(19) United States
(12) Patent Application Publication
(10) Pub. No.: US 2026/0299235 A1
(43) Pub. Date: Oct. 1, 2026

(54) ELECTRONIC DEVICE

(71) Applicant: Advanced Semiconductor Engineering, Inc., Kaohsiung (TW)

(72) Inventors: Cheng-Ting CHEN, Kaohsiung (TW); Chang-Yu LIN, Kaohsiung (TW); Hai-Ming CHEN, Kaohsiung (TW); Chi-Han CHEN, Kaohsiung (TW); Hung-Yi LIN, Kaohsiung (TW)

(73) Assignee: Advanced Semiconductor Engineering, Inc., Kaohsiung (TW)

(21) Appl. No.: 19/093,181

(22) Filed: Mar. 27, 2025

(51) Int. Cl. G02B 6/43; G02B 6/42

(52) U.S. Cl. CPC G02B 6/43; G02B 6/4214; G02B 6/4245

(57) ABSTRACT

An electronic device is provided. The electronic device includes a photonic component, an optical guiding element, and a reinforcement element. The photonic component includes a first region and a second region having a thickness less than a thickness of the first region. The optical guiding element is disposed over the second region and is configured to direct a first optical signal upwardly and away from the photonic component. The reinforcement element is disposed over the first region.

### BACKGROUND

### 1. Technical Field

The present disclosure relates generally to an electronic device.

### 2. Description of the Related Art

Due to the significantly higher bandwidth of optical signals compared to electrical signals, optical signals are used for transmission between servers of data centers, and optical modules may be arranged with corresponding electronic components of the servers for providing photoelectric conversion. The optical module may be or include one or more pluggable optical modules; however, the distance between the electronic component and the pluggable optical module is relatively far, resulting in larger overall component size and higher power consumption. To solve the above issues, a co-packaged optics (CPO) architecture integrating the electronic component and the optical module is provided. Researchers in the field of silicon photonics technology are still striving to develop improvements in the optical coupling structures of the CPO architecture and optical fiber array units (FAUs).

### SUMMARY

In one or more arrangements, an electronic device includes a photonic component, an optical guiding element, and a reinforcement element. The photonic component includes a first region and a second region having a thickness less than a thickness of the first region. The optical guiding element is disposed over the second region and is configured to direct a first optical signal upwardly and away from the photonic component. The reinforcement element is disposed over the first region.

In one or more arrangements, an electronic device includes a photonic component, an optical component, an optical guiding element, and a leveling element. The photonic component has a non-uniform thickness. The optical component is disposed over the photonic component. The optical guiding element is configured to optically couple the photonic component to the optical component. The leveling element is configured to increase an optical coupling efficiency between the photonic component and the optical component.

In one or more arrangements, an electronic device includes a photonic component, an optical guiding element, and a reinforcement element. The photonic component has a cavity. The optical guiding element is configured to optically couple to the photonic component and includes an extension in the cavity. The reinforcement element is disposed over the photonic component and around the optical guiding element.

### BRIEF DESCRIPTION OF THE DRAWINGS

Aspects of the present disclosure are better understood from the following detailed description when read with the accompanying drawings. It is noted that various features may not be drawn to scale, and the dimensions of the various features may be arbitrarily increased or reduced for clarity of discussion.

FIG. 1A illustrates a data communication system in accordance with some arrangements of the present disclosure.

FIG. 1B is a top view of an electronic device in accordance with some arrangements of the present disclosure.

FIG. 1C is a cross-section of an electronic device in accordance with some arrangements of the present disclosure.

FIG. 1D is a top view of an electronic device in accordance with some arrangements of the present disclosure.

FIG. 1E is a cross-section of an electronic device in accordance with some arrangements of the present disclosure.

FIG. 1F is a cross-section illustrating a data communication system in accordance with some arrangements of the present disclosure.

FIG. 2A is a cross-section of an electronic device in accordance with some arrangements of the present disclosure.

FIG. 2B is a cross-section of an electronic device in accordance with some arrangements of the present disclosure.

FIG. 2C is a top view of an electronic device in accordance with some arrangements of the present disclosure.

FIG. 2D is a top view of an electronic device in accordance with some arrangements of the present disclosure.

FIG. 2E is a top view of an electronic device in accordance with some arrangements of the present disclosure.

FIG. 2F is a top view of an electronic device in accordance with some arrangements of the present disclosure.

FIG. 2G and FIG. 2H show simulation results of warpage of electronic devices in accordance with some arrangements of the present disclosure.

FIG. 3A is a cross-section of an electronic device in accordance with some arrangements of the present disclosure.

FIG. 3B is a cross-section of an electronic device in accordance with some arrangements of the present disclosure.

FIG. 3C is a top view of an electronic device in accordance with some arrangements of the present disclosure.

FIG. 4A is a cross-section of an electronic device in accordance with some arrangements of the present disclosure.

FIG. 4B is a top view of an electronic device in accordance with some arrangements of the present disclosure.

FIG. 5A is a cross-section of an electronic device in accordance with some arrangements of the present disclosure.

FIG. 5B is a top view of an electronic device in accordance with some arrangements of the present disclosure.

FIG. 6A is a cross-section of an electronic device in accordance with some arrangements of the present disclosure.

FIG. 6B is a cross-section of an electronic device in accordance with some arrangements of the present disclosure.

FIG. 7A, FIG. 7B, FIG. 7C, FIG. 7D, and FIG. 7E illustrate various stages of an exemplary method for manufacturing an electronic device in accordance with some embodiments of the present disclosure.

FIG. 8A, FIG. 8B, FIG. 8C, and FIG. 8D illustrate various stages of an exemplary method for manufacturing an electronic device in accordance with some embodiments of the present disclosure.

FIG. 9A, FIG. 9B, and FIG. 9C illustrate various stages of an exemplary method for manufacturing an electronic device in accordance with some embodiments of the present disclosure.

FIG. 10A, FIG. 10B, FIG. 10C, and FIG. 10D illustrate various stages of an exemplary method for manufacturing an electronic device in accordance with some embodiments of the present disclosure.

Common reference numerals are used throughout the drawings and the detailed description to indicate the same or similar elements. The present disclosure will be more apparent from the following detailed description taken in conjunction with the accompanying drawings.

### DETAILED DESCRIPTION

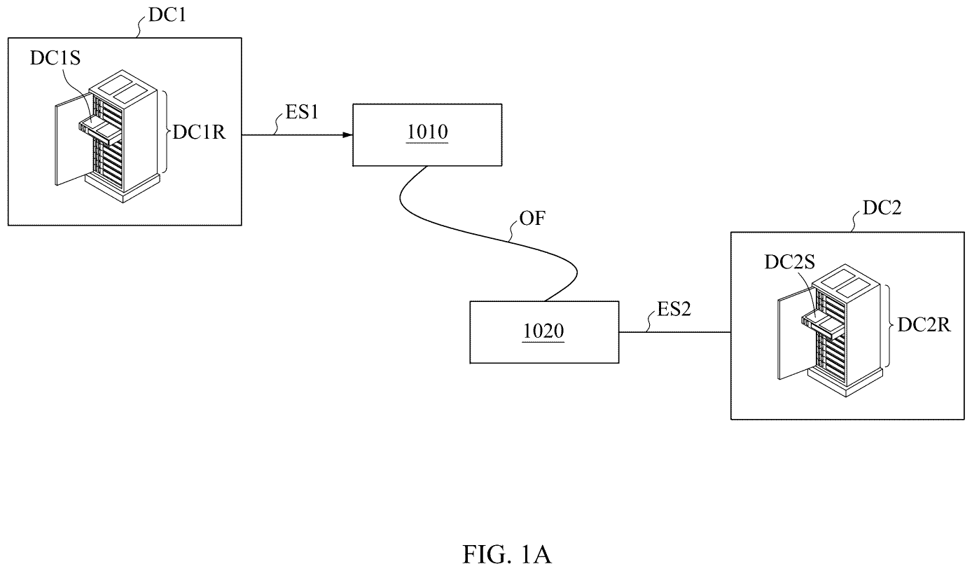

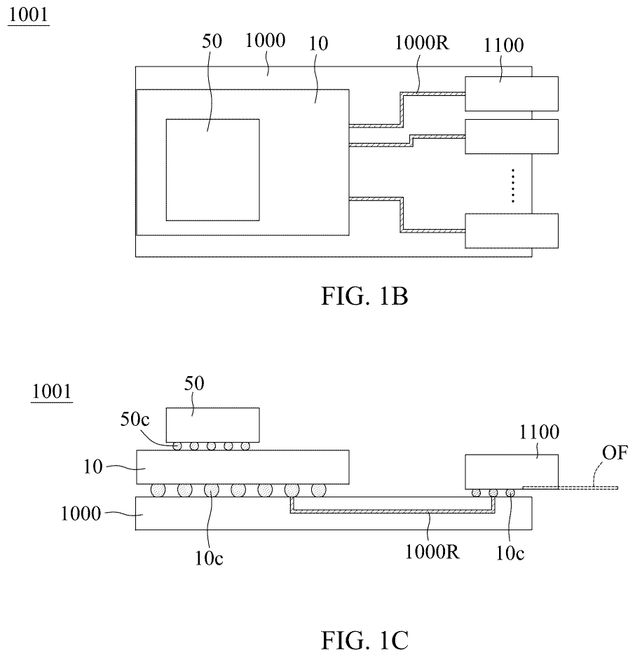

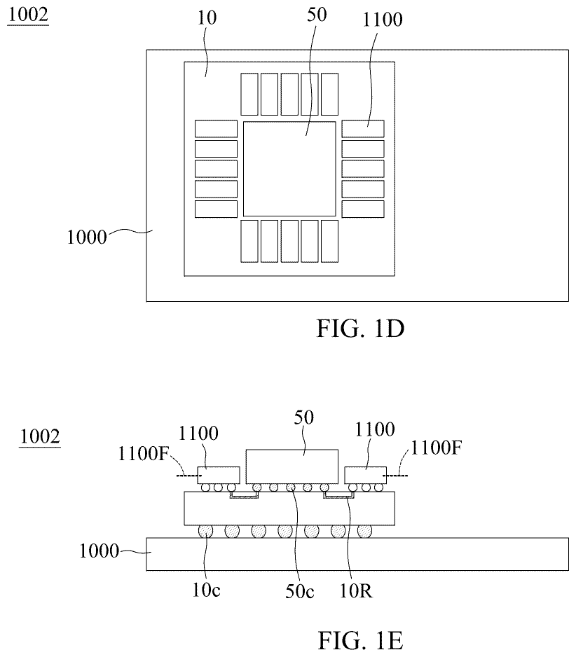

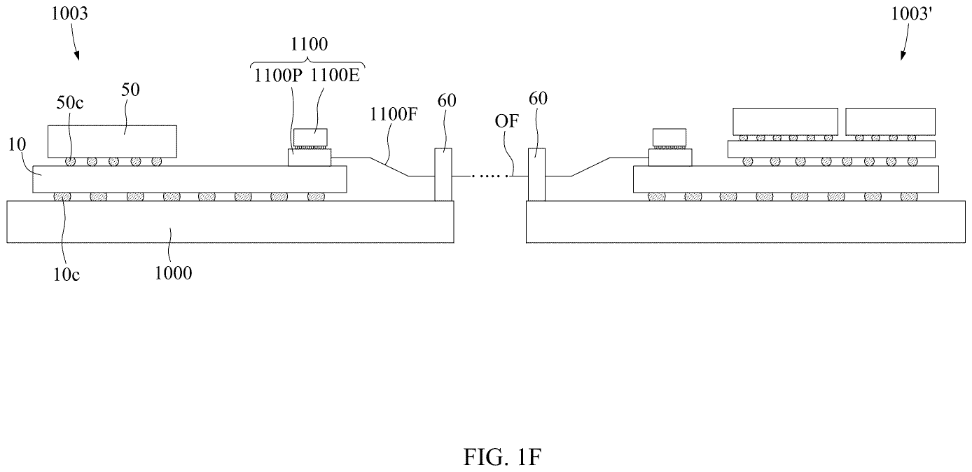

FIG. 1A illustrates a data communication system in accordance with some arrangements of the present disclosure. Data communication between a data center DC1 and a data center DC2 may be achieved by optical communication through at least an optical transmitter module 1010, an optical receiving module 1020, and one or more optical fibers OF. The data center DC1 may include a server rack DC1R including servers DCIS, and the data center DC2 may include a server rack DC2R including servers DC2S.

Due to the significantly higher bandwidth of optical signals compared to electrical signals, optical signals are used for transmission between servers of data centers DC1 and DC2. Electrical signals ES1 including on and off signals from the server of the data center DC1 may be converted to optical signals including light and dark signals by the optical transmitter module 1010 through the optical fibers OF. At the receiving end, the optical receiver module 1020 may convert the optical signals with the light and dark signals back into the electrical signals ES2 including on and off signals.

FIG. 1B is a top view of an electronic device 1001 in accordance with some arrangements of the present disclosure. FIG. 1C is a cross-section of an electronic device 1001 in accordance with some arrangements of the present disclosure. FIG. 1C may be a cross-section of the electronic device 1001 illustrated in FIG. 1B. The electronic device 1001 may be at least one of the optical transmitter module 1010 and the optical receiving module 1020.

The electronic device 1001 may include a substrate 1000, a substrate 10 and an optical module 1100 over and connected to the substrate 1000 through electrical contacts 10c, and an electronic component 50 over and electrically connected to the substrate 10 through electrical contacts 50c. The optical module 1100 may be connected to optical fibers OF. The substrate 1000 may be or include a printed circuit board (PCB) or a system board, and the substrate 1000 may include conductive structure 1000R electrically connecting the substrate 10 to the optical module 1100. The electronic component 50 may be or include a switch chip. The optical module 1100 may be configured to provide a photoelectric conversion. The optical module 1100 may be or include an optical engine. In some arrangements, the electronic device 1001 serving as an optical transmitter module or an optical receiving module may include one or more pluggable optical modules (e.g., the optical module 1100). However, the distance between the electronic component 50 (or the switch chip) and the optical module 1100 (or the pluggable optical module) is relatively far, resulting in larger overall component size and higher power consumption.

FIG. 1D is a top view of an electronic device 1002 in accordance with some arrangements of the present disclosure. FIG. 1E is a cross-section of an electronic device 1002 in accordance with some arrangements of the present disclosure. FIG. 1E may be a cross-section of the electronic device 1002 illustrated in FIG. 1D. The electronic device 1002 may be at least one of the optical transmitter module 1010 and the optical receiving module 1020.

The electronic device 1002 may include a substrate 1000, a substrate 10 over and electrically connected to the substrate 1000 through electrical contacts 10c, and optical modules 1100 and an electronic component 50 over and connected to the substrate 10 through electrical contacts 50c. The optical module 1100 may be connected to optical fibers 1100F. The substrate 1000 may be or include a printed circuit board (PCB) or a system board. The electronic component 50 may be or include a switch chip. The optical module 1100 may be configured to provide a photoelectric conversion. The optical module 1100 may be or include an optical engine. The substrate 10 may include a conductive structure 10R electrically connecting the electronic component 50 to the optical modules 1100.

The electronic device 1002 may feature a co-packaged optics (CPO) architecture. By utilizing mature silicon wafer and semiconductor processes, the previously separate electronic component 50 and optical modules 1100 can be integrated into a miniaturized chip (such as the electronic device 1002), which is known as silicon photonics technology. The integration of the electronic component 50 and the optical modules 1100 into the electronic device 1002 offers advantages of smaller component size and lower power consumption. The electronic device 1002 can be applied in data centers, suitable for short-distance data transmission, and can also be used for long-distance data transmission via fiber optic networks.

FIG. 1F is a cross-section illustrating a data communication system in accordance with some arrangements of the present disclosure. FIG. 1F may illustrate a data communication between electronic devices 1003 and 1003′. The data communication system may include electronic devices 1003 and 1003′, optical components 60, and optical fibers OF.

The electronic devices 1003 and 1003′ each may include a substrate 1000, a substrate 10 over and electrically connected to the substrate 1000 through electrical contacts 10c, and at least an optical module 1100 and an electronic component 50 over and connected to the substrate 10 through electrical contacts 50c. The optical module 1100 may be connected to optical fibers 1100F. The substrate 1000 may be or include a printed circuit board (PCB) or a system board. The electronic component 50 may be or include a switch chip. The optical module 1100 may be configured to provide a photoelectric conversion. The optical module 1100 may be or include an optical engine. The optical module 1100 may include a photonic component 1100P (e.g., a photonic integrated circuit (PIC)) and an electronic component 1100E (e.g., an electronic integrated circuit (EIC)) electrically connected to the photonic component 1100P. The substrate 10 may include a conductive structure electrically connecting the electronic component 50 to the optical modules 1100. The electronic devices 1003 and 1003′ may feature CPO architectures. The electronic devices 1003 and 1003′ can be applied in data centers and can also be used for long-distance data transmission via fiber optic networks (e.g., through the optical components 60 and the optical fibers OF).

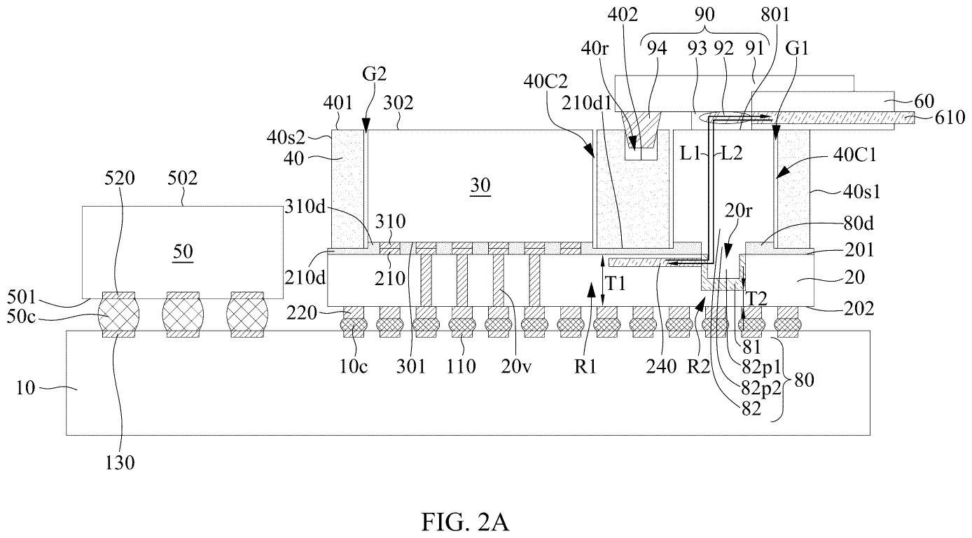

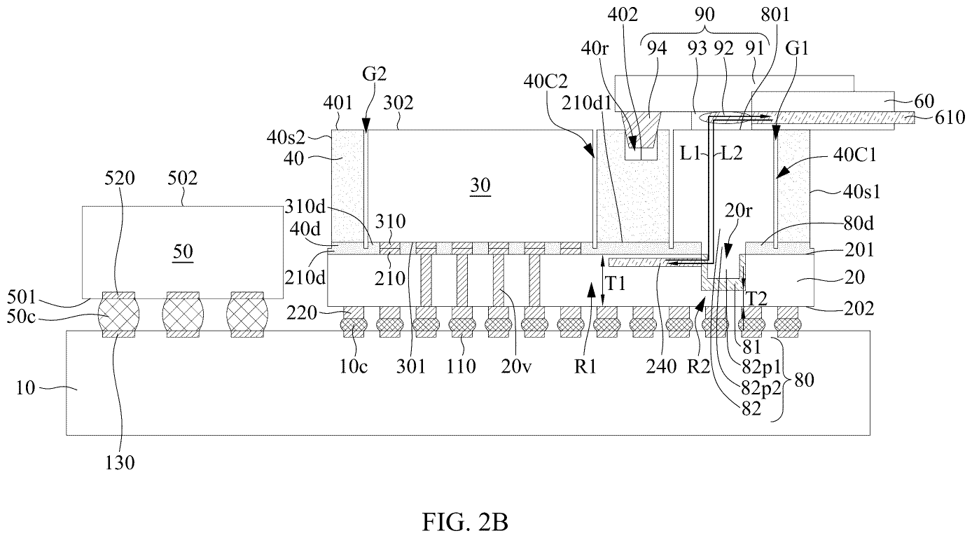

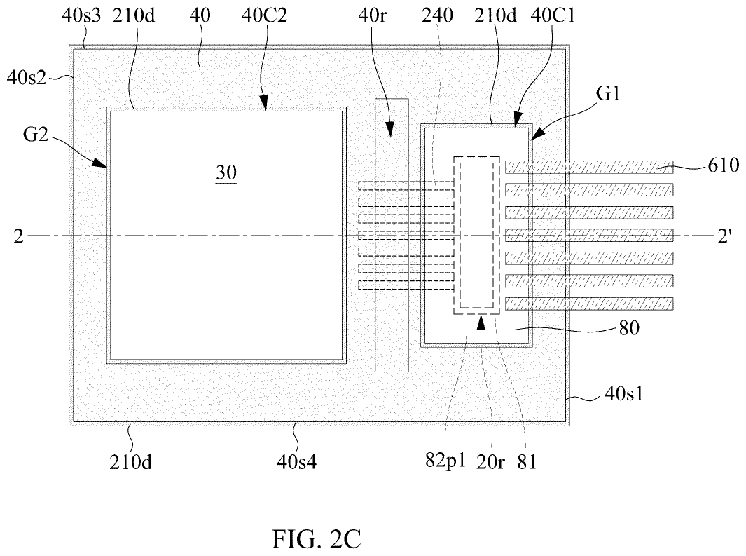

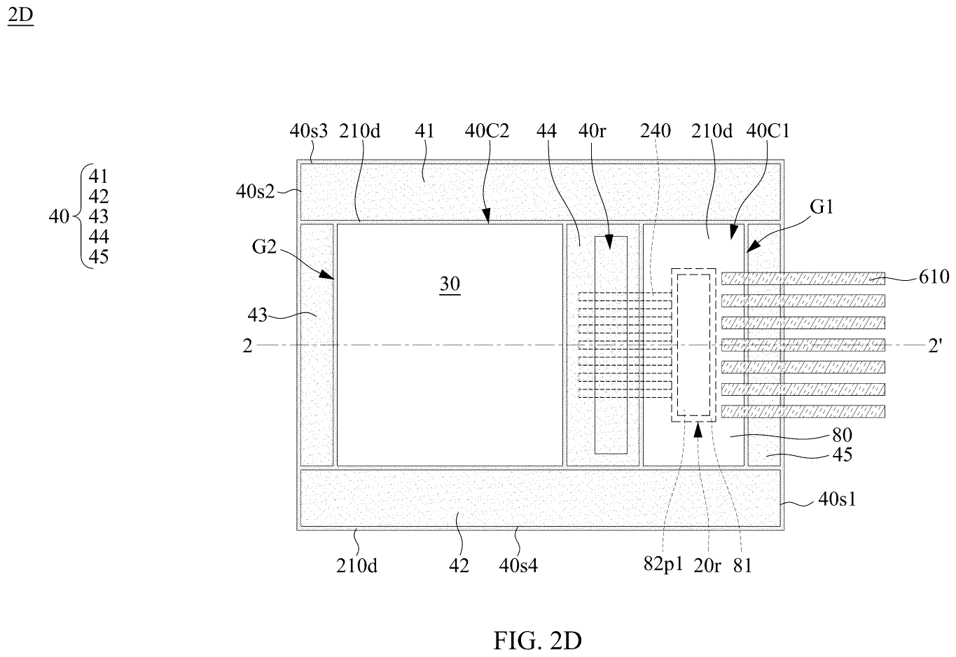

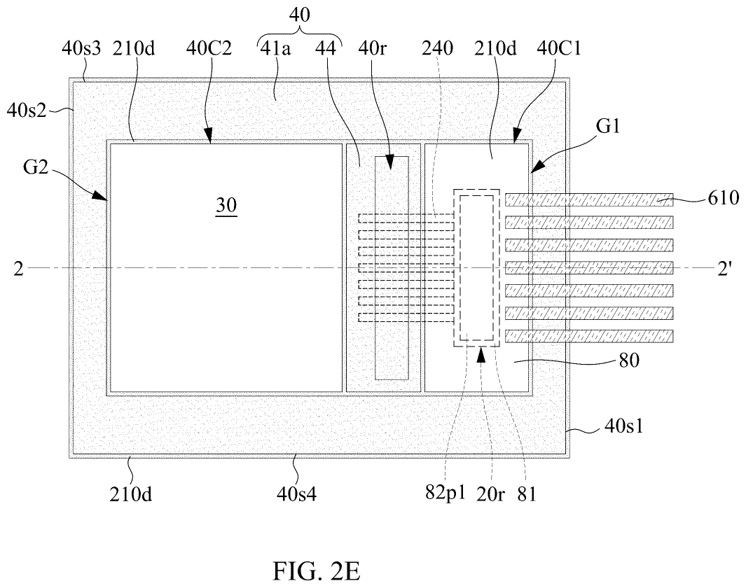

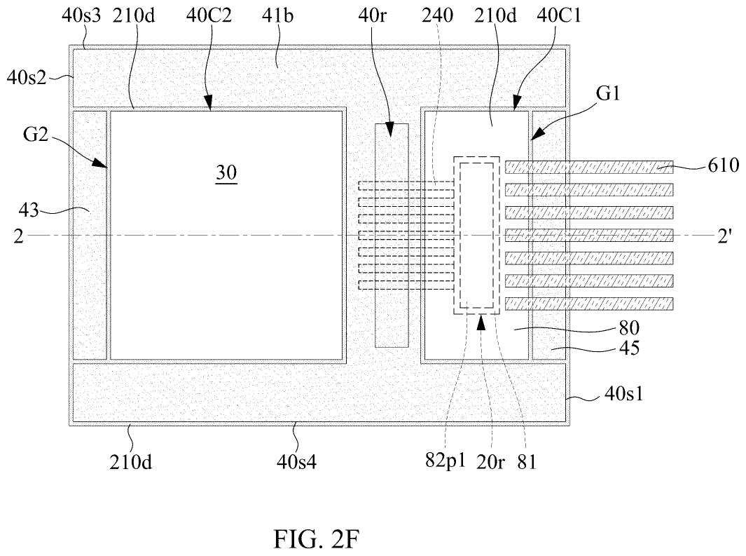

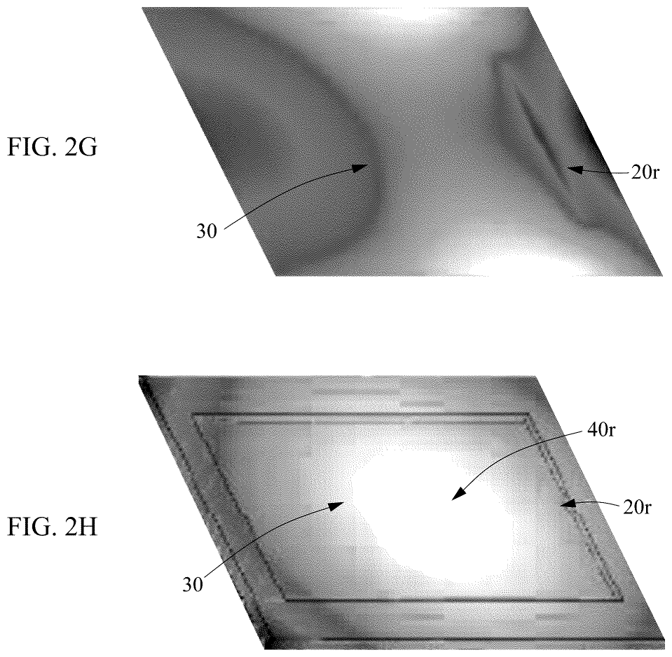

FIG. 2A is a cross-section of an electronic device 2A in accordance with some arrangements of the present disclosure. The electronic device 2A may include a substrate 10, a photonic component 20, electronic components 30 and 50, a reinforcement element 40 (also referred to as “a leveling element”), an optical component 60, an optical element 80 (also referred to as “an optical guiding element”), a photonic plug 90 (also referred to as “a photonic connector”), and electrical contacts 10c and 50c. In some arrangements, the electronic device 2A may be or include an optoelectronic package. The electronic device 2A may be at least one of the optical transmitter module 1010 and the optical receiving module 1020 illustrated in FIG. 1A. The electronic device 2A may feature a co-packaged optics (CPO) architecture.

The substrate 10 may support the photonic component 20, the electronic components 30 and 50, the reinforcement element 40, the optical component 60, the optical element 80, and the photonic plug 90. The substrate 10 may include, for example, a printed circuit board, such as a paper-based copper foil laminate, a composite copper foil laminate, or a polymer-impregnated glass-fiber-based copper foil laminate. The substrate 10 may include an interconnection structure, such as a plurality of conductive traces and a plurality of conductive vias. In some embodiments, the substrate 10 includes a ceramic substrate, a metal plate, an organic substrate, or a leadframe. In some embodiments, the substrate 10 may include a two-layer substrate which includes a core layer and a conductive material and/or structure disposed on an upper surface and a bottom surface of the substrate 10. The conductive material and/or structure may include a plurality of conductive traces. In some arrangements, the substrate 10 includes conductive pads 110 and 130.

The photonic component 20 may be disposed over and electrically connected to the substrate 10. The photonic component 20 may have a surface 202 facing the substrate 10 and a surface 201 opposite to the surface 202. The surface 201 may be an active surface. The surface 202 may be a backside surface or a passive surface. In some arrangements, the photonic component 20 is configured to optically couple to one or more optical components (e.g., the optical component 60). The photonic component 20 may be or include a photonic integrated circuit (PIC), a laser diode, a receiver, a waveguide, a photodetector, a photodiode, a semiconductor optical amplifier (SOA), a grating coupler, a fiber coupling structure, an optical modulator (e.g., Mach-Zehnder modulator or microring modulator), or a combination thereof.

In some arrangements, the photonic component 20 includes conductive pads 210 and 220, at least a dielectric layer 210d, conductive vias 20v, and at least an optical channel 240. The photonic component 20 may include a substrate layer, which may be or include a semiconductor layer, e.g., a silicon layer. The photonic component 20 may include a circuit layer at or adjacent to the surface 201. The circuit layer may include one or more circuits configured to provide a photoelectric conversion. The conductive vias 20v may electrically connect the surface 201 (or the circuit layer) to the surface 202. The conductive vias 20v may be referred to as through silicon vias (TSVs). In some arrangements, the photonic component 20 is electrically connected to the substrate 10 through the conductive pads 220, the conductive pads 110, and electrical contacts 10c. The optical channel 240 may be configured to optically couple to the optical component 60. The optical channel 240 may be or include an optical waveguide. The conductive pads 210 and 220 and the conductive vias 20v may include one or more conductive materials such as a metal or metal alloy. Examples include gold (Au), silver (Ag), aluminum (Al), copper (Cu), or an alloy thereof. The dielectric layer 210d may include, for example, one or more organic materials (e.g., phosphoric anhydride (PA), polyimide (PI), polybenzoxazole (PBO), epoxy, and an epoxy-based material) or one or more inorganic materials (e.g., silicon oxide, silicon nitride, glass, and ceramic). In some arrangements, the dielectric layer 210d is or includes PI. The electrical contacts 10c may be or include conductive bumps, e.g., solder bumps.

In some arrangements, the photonic component 20 has a non-uniform thickness. In some arrangements, the photonic component 20 has different thicknesses at different regions. In some arrangements, the photonic component 20 includes a region R1 (also referred to as “a thick region”) having a thickness T1 and a region R2 (also referred to as “a thin region”) having a thickness T2 less than the thickness T1. The thickness T1 may be equal to or less than about 100 μm, 80 μm, 60 μm, or 50 μm. The thickness T1 may be about 50 μm to about 100 μm. In some arrangements, the photonic component 20 has a cavity 20r (also referred to as “a recess”) defining the region R2, and the optical channel 240 is exposed to the cavity 20r.

The electronic component 30 may be disposed or stacked over the photonic component 20. The electronic component 30 may have a surface 301 facing the photonic component 20 and a surface 302 opposite to the surface 301. The surface 301 may be an active surface. The upper surface 402 may be a backside surface or a passive surface. In some arrangements, the electronic component 30 is electrically connected to the photonic component 20. In some arrangements, the electronic component 30 is disposed over the region R1 of the photonic component 20 and spaced apart from the optical element 80 by the reinforcement element 40. In some arrangements, the electronic component 30 is electrically connected to the substrate 10 through the conductive vias 20v in the photonic component 20. In some arrangements, the electronic component 30 includes conductive pads 310 and at least a dielectric layer 310d. In some arrangements, the electronic component 30 is electrically connected to the photonic component 20 through the conductive pads 310 and the conductive pads 210. In some arrangements, the conductive pads 310 are connected to the conductive pads 210 through a direct bonding process or a thermal bonding process. In some arrangements, the dielectric layer 310d is connected to the dielectric layer 210d through a thermal bonding process. In some arrangements, the electronic component 30 is electrically connected to the photonic component 20 through a hybrid bond structure including the conductive pads 210 and 310 and the dielectric layers 210d and 310d. The conductive pads 310 may include Au, Ag, Al, Cu, Ni, or an alloy thereof. The dielectric layer 310d may include, for example, one or more organic materials (e.g., PA, PI, PBO, epoxy, and an epoxy-based material) or one or more inorganic materials (e.g., silicon oxide, silicon nitride, glass, and ceramic). In some arrangements, the dielectric layer 310d is or includes PI. The electronic component 30 may be or include an electronic integrated circuit (EIC). In some arrangements, the electronic component 30 includes a logic circuit. In some arrangements, the electronic component 30 includes a modulator driver (DRV), a trans-impedance amplifier (TIA), or a combination thereof. The electronic component 30 may have a thickness equal to or greater than the thickness T1 of the photonic component 20.

The reinforcement element 40 may be disposed over the region R1 of the photonic component 20. In some arrangements, the reinforcement element 40 is disposed between the photonic component 20 and the optical component 60. In some arrangements, the reinforcement element 40 is disposed between the photonic component 20 and the photonic plug 90. In some arrangements, the reinforcement element 40 is disposed over the photonic component 20 and around the optical element 80. In some arrangements, the reinforcement element 40 contacts the optical element 80. In some arrangements, the reinforcement element 40 is connected to the dielectric layer 210d. In some arrangements, the reinforcement element 40 contacts an upper surface 210d1 of the dielectric layer 210d. In some arrangements, the reinforcement element 40 (or the leveling element) is configured to reduce a warpage of the photonic component 20. In some arrangements, the reinforcement element 40 (or the leveling element) is configured to increase an optical coupling efficiency between the photonic component 20 and the optical component 60. The reinforcement element 40 may be or include a dummy die. The reinforcement element 40 may include a semiconductor material, such as a silicon layer or a silicon substrate.

In some arrangements, the reinforcement element 40 defines an alignment region 40r configured to engage with the photonic plug 90. The alignment region 40r may be or include a recess or a cavity recessed from an upper surface 401 of the reinforcement element 40. A bottom surface of the recess or the cavity may be defined by an upper surface 402 of the reinforcement element 40. The upper surface 401 may be substantially aligned or coplanar with the surface 302, and the upper surface 402 is at an elevation lower than that of the upper surface 401 with respect to the surface 201.

In some arrangements, the reinforcement element 40 (or the leveling element) defines through holes 40C1 and 40C2 (may be referred to as “spaces”). In some arrangements, the cavity 20r (or the recess) of the photonic component 20 is directly under the through hole 40C1 (or the space). In some arrangements, the through hole 40C1 (or the space) accommodates the optical element 80. In some arrangements, the optical element 80 is spaced apart from the reinforcement element 40 by a gap G1. In some arrangements, the through hole 40C2 accommodates the electronic component 30. In some arrangements, the electronic component 30 is spaced apart from the reinforcement element 40 by a gap G2. In some arrangements, lateral surfaces 40s1 and 40s2 of the reinforcement element 40 are recessed with respect to lateral surfaces of the dielectric layer 210d.

The electronic component 50 may be disposed over and electrically connected to the substrate 10. The electronic component 50 may have a surface 501 facing the substrate 10 and a surface 502 opposite to the surface 501. The surface 501 may be an active surface. The surface 502 may be a backside surface or a passive surface. In some arrangements, the electronic component 50 includes conductive pads 520 exposed by the surface 501. In some arrangements, the electronic component 50 is electrically connected to the photonic component 20 through the substrate 10. In some arrangements, the electronic component 50 may be or include a processing component, e.g., an ASIC, an FPGA, a GPU, or the like, or a combination thereof.

The optical component 60 may be disposed over the photonic component 20. In some arrangements, the optical component 60 is optically coupled to the photonic component 20. In some arrangements, the optical component 60 includes one or more optical fibers 610. In some arrangements, the optical component 60 is or includes an optical fiber array unit (FAU). In some arrangements, the photonic component 20 (or the optical channel 240) is configured to optically couple to the optical component 60 (or the optical fiber 610). In some arrangements, a width of the optical channel 240 is less than a width of the optical fiber 610.

The optical element 80 may be disposed over the region R2 of the photonic component 20. In some arrangements, the optical element 80 (or the optical guiding element) is configured to optically couple to the photonic component 20. In some arrangements, the optical element 80 (or the optical guiding element) is configured to optically couple the photonic component 20 to the optical component 60. In some arrangements, the optical element 80 (or the optical guiding element) is configured to optically couple the photonic component 20 to the optical component 60 through the photonic plug 90 (or the photonic connector). In some arrangements, the optical element 80 (or the optical guiding element) is configured to transmit an optical signal L1 from the photonic component 20 to the optical component 60 through vertical coupling. In some arrangements, the optical element 80 (or the optical guiding element) is configured to direct the optical signal L1 upwardly and away from the photonic component 20. In some arrangements, the optical element 80 (or the optical guiding element) is configured to transmit an optical signal L2 from the optical component 60 to the photonic component 20 through vertical coupling. In some arrangements, the optical element 80 (or the optical guiding element) is configured to direct the optical signal L2 downwardly and away from the photonic plug 90 (or the optical component 60).

In some arrangements, the optical element 80 (or the optical guiding element) includes an optical gel 81, a portion 82, and portions 82p1 and 82p2 (also referred to as “extensions”) protruding from the portion 82. In some arrangements, the portion 82 and the portions 82p1 and 82p2 are or form a monolithic piece or an integral structure. In some arrangements, the portion 82 and the portions 82p1 and 82p2 collectively form a transmission medium of the optical element 80. In some arrangements, the transmission medium tapers toward the surface 202 with a width of the portion 82p1 less than a width of the portion 82p2, and a width of the portion 82 is greater than the widths of the portions 82p1 and 82p2. In some arrangements, the portions 82p1 and 82p2 have reduced widths compared to a width of the portion 82. In some arrangements, the optical gel 81 and the portion 82p1 are disposed in or extending into the cavity 20r (or the recess). In some arrangements, the optical gel 81 surrounds and contacts the portion 82p1. In some arrangements, the optical channel 240 is exposed to the cavity 20r and contacts the optical gel 81. In some arrangements, the gap between sidewalls of the cavity 20r and the portion 82p1 (or the transmission medium) is filled with the optical gel 81. In some arrangements, the gap between the optical channel 240 exposed to the cavity 20r and the portion 82p1 (or the transmission medium) in the cavity 20r is filled with the optical gel 81. In some arrangements, the reinforcement element 40 is around or surrounds the optical element 80. In some arrangements, the portion 82p1 may be or include a reflective element in the cavity 20r (or the recess). In some arrangements, the reflective element (e.g., the portion 82p1) is configured to reflect the optical signal L1 to switch it from transmitting in a substantially horizontal direction to a substantially vertical direction. In some arrangements, the reflective element (e.g., the portion 82p1) is configured to reflect the optical signal L2 to switch it from transmitting in a substantially vertical direction to a substantially horizontal direction. In some arrangements, the portion 82p2 may be or include a connection element connecting the reflective element to the portion 82 of the optical element 80.

The optical element 80 (or the optical guiding element) may have an upper surface 801 facing the optical component 60 and the photonic plug 90. In some arrangements, an upper surface (e.g., the surface 302) of the electronic component 30 is substantially aligned with the upper surface 801 of the optical element 80. In some arrangements, the optical element 80 is connected to the photonic component 20 through dielectric layers 80d and 210d. In some arrangements, the dielectric layer 80d is connected to the dielectric layer 210d through a thermal bonding process.

The photonic plug 90 may be disposed over the photonic component 20 and the optical element 80 (or the optical guiding element). In some arrangements, the photonic plug 90 is optically coupled to the optical component 60. In some arrangements, the photonic plug 90 is configured to optically couple the optical component 60 to the optical element 80. In some arrangements, the photonic plug 90 is configured to guide the optical signal L1 away from the optical element 80. In some arrangements, the photonic plug 90 is configured to guide the optical signal L2 to the optical element 80. In some arrangements, the photonic plug 90 and the optical element 80 collectively are configured to transmit at least an optical signal (e.g., the optical signals L1 and L2) between the photonic component 20 and the optical component 60 and change a beam size of the optical signal (e.g., the optical signals L1 and L2). In some arrangements, the photonic plug 90 and the optical element 80 collectively are configured to transmit the optical signal L1 from the photonic component 20 to the optical component 60 and change a beam size of the optical signal L1. In some arrangements, the photonic plug 90 and the optical element 80 collectively are configured to transmit the optical signal L1 from the photonic component 20 to the optical component 60 and enlarge a beam size of the optical signal L1. In some arrangements, the photonic plug 90 and the optical element 80 collectively are configured to transmit the optical signal L2 from the optical component 60 to the photonic component 20 and reduce a beam size of the optical signal L2.

In some arrangements, the photonic plug 90 (or the photonic connector) includes a support 91, an optical director 92, a covering element 93, and a protrusion 94. In some arrangements, the support 91 defines a recess to receive the optical component 60 and fix the optical component 60 to the optical element 80. In some arrangements, the optical director 92, the covering element 93, and the protrusion 94 are disposed on and connected to the support 91. In some arrangements, the covering element 93 covers the optical director 92 and contacts the optical element 80. In some arrangements, the protrusion 94 is configured to engage with a recess (e.g., the alignment region 40r) defined by the reinforcement element 40.

In some arrangements, the optical director 92 is disposed over the optical element 80 (or the optical guiding element). In some arrangements, the optical director 92 is configured to switch at least an optical signal (e.g., the optical signals L1 and L2) between transmitting in non-parallel directions. In some arrangements, the optical director 92 is configured to switch the optical signal L1 from transmitting in a substantially vertical direction to a substantially horizontal direction. In some arrangements, the optical director 92 is configured to switch the optical signal L2 from transmitting in a substantially horizontal direction to a substantially vertical direction. In some arrangements, the optical director 92 and the reflective element (e.g., the portion 82p1) collectively are configured to transmit the optical signal L1 from the photonic component 20 to the optical component 60 and change a beam size of the optical signal L1. In some arrangements, the optical director 92 and the reflective element (e.g., the portion 82p1) collectively are configured to transmit the optical signal L1 from the photonic component 20 to the optical component 60 and enlarge a beam size of the optical signal L1. In some arrangements, the optical director 92 and the reflective element (e.g., the portion 82p1) collectively are configured to transmit the optical signal L2 from the optical component 60 to the photonic component 20 and reduce a beam size of the optical signal L2. The optical director 92 may include a lens, a prism, or a combination thereof.

FIG. 2B is a cross-section of an electronic device 2B in accordance with some arrangements of the present disclosure. The electronic device 2B is similar to the electronic device 2A, and the differences therebetween are described as follows.

In some arrangements, the reinforcement element 40 is connected to the photonic component 20 through dielectric layers 40d and 210d. In some arrangements, the dielectric layer 40d is connected to the dielectric layer 210d through a thermal bonding process. In some arrangements, the dielectric layer 40d and the dielectric layer 210d may be half-cured prior to being bonded to each other, and then the half-cured dielectric layer 40d and the half-cured dielectric layer 210d are brought to contact or bond to each other followed by a full curing operation to form chemical bonding between the dielectric layers 40d and 210d so as to connect them to each other. In some arrangements, lateral surfaces of the dielectric layer 40d are recessed with respect to lateral surfaces of the dielectric layer 210d.

FIG. 2C is a top view of an electronic device 2C in accordance with some arrangements of the present disclosure. In some arrangements, FIG. 2A shows a cross-section along a line 2-2′ in FIG. 2C. In some arrangements, FIG. 2B shows a cross-section along a line 2-2′ in FIG. 2C.

In some arrangements, portions of the dielectric layer 210d are exposed by the gaps G1 and G2 from a top view perspective. In some arrangements, lateral surfaces 40s1, 40s2, 40s3, and 40s4 of the reinforcement element 40 are recessed with respect to lateral surfaces of the dielectric layer 210d.

Referring to FIG. 2A and FIG. 2C, in some arrangements, the photonic plug 90 and the optical element 80 collectively are configured to transmit the optical signals L1 from the optical channels 240 of the photonic component 20 to the optical fibers 610 of the optical component 60 and enlarge a pitch of the optical signals L1. Referring to FIG. 2A and FIG. 2C, in some arrangements, the photonic plug 90 and the optical element 80 collectively are configured to transmit the optical signals L2 from the optical fibers 610 of the optical component 60 to the optical channels 240 of the photonic component 20 and reduce a pitch of the optical signals L2.

FIG. 2D is a top view of an electronic device 2D in accordance with some arrangements of the present disclosure. In some arrangements, FIG. 2A shows a cross-section along a line 2-2′ in FIG. 2D. In some arrangements, FIG. 2B shows a cross-section along a line 2-2′ in FIG. 2D.

In some arrangements, the reinforcement element 40 includes a plurality of reinforcement parts 41, 42, 43, 44, and 45. In some arrangements, the dielectric layer 210d is exposed by gaps between the reinforcement parts 41, 42, 43, 44, and 45 from a top view perspective.

FIG. 2E is a top view of an electronic device 2E in accordance with some arrangements of the present disclosure. In some arrangements, FIG. 2A shows a cross-section along a line 2-2′ in FIG. 2E. In some arrangements, FIG. 2B shows a cross-section along a line 2-2′ in FIG. 2E.

In some arrangements, the reinforcement element 40 includes a plurality of reinforcement parts 41a and 45. In some arrangements, the dielectric layer 210d is exposed by gaps between the reinforcement parts 41a and 45 from a top view perspective.

FIG. 2F is a top view of an electronic device 2F in accordance with some arrangements of the present disclosure. In some arrangements, FIG. 2A shows a cross-section along a line 2-2′ in FIG. 2F. In some arrangements, FIG. 2B shows a cross-section along a line 2-2′ in FIG. 2F.

In some arrangements, the reinforcement element 40 includes a plurality of reinforcement parts 41b, 43, and 45. In some arrangements, the dielectric layer 210d is exposed by gaps between the reinforcement parts 41b, 43, and 45 from a top view perspective.

Simulation results are presented in Tables 1-2 below to show the influences of the thickness of the electronic component 30, the size of the optical element 80, the thickness of the optical element 80, the coefficient of thermal expansion (CTE) of the optical element 80, the size of the cavity 20r of the photonic component 20, and the depth of the cavity 20r of the photonic component 20 on the warpage of the entire surface 201 of the photonic component 20 and the warpage of a local portion (e.g., referring to a region proximal to the cavity 20r illustrated in FIGS. 2A-2F) at different temperatures (at room temperature (RT) and at an elevation temperature of 260° C.) without arranging a reinforcement element 40.

TABLE 1

| | C1 | C2 | C3 | C4 | C5 |
|---|---|---|---|---|---|
| Size of cavity 20r (length*width) (mm) | 5.6*0.35 | 5.6*0.35 | 5.6*0.35 | 5.6*0.35 | 5.6*0.35 |
| Depth of cavity 20r (length*width) (μm) | 15 | 15 | 15 | 20 | 25 |
| Thickness of electronic component 30 (mm) | 700 | 700 | 700 | 700 | 700 |
| Size of optical element 80 (length*width) (mm) | 6*1.6 | 6*1.6 | 6*1.6 | 6*1.6 | 6*1.6 |
| Thickness of optical element 80 (length*width) (μm) | 200 | 300 | 700 | 200 | 200 |
| CTE of optical element 80 (ppm/° C.) | 4.6 | 4.6 | 4.6 | 4.6 | 4.6 |
| Warpage (μm) | | | | | |
| Entire surface at RT | 3.67 | 3.61 | 3.40 | 3.72 | 3.76 |
| Entire surface at 260° C. | 13.19 | 10.77 | 4.73 | 13.15 | 13.09 |
| Local portion at RT | 1.71 | 1.62 | 1.33 | 1.74 | 1.77 |
| Local portion at 260° C. | 7.15 | 6.23 | 3.07 | 7.14 | 7.12 |

TABLE 2

| | C6 | C7 | C8 | C9 |
|---|---|---|---|---|
| Size of cavity 20r (length*width) (mm) | 5.6*0.35 | 6*0.35 | 6.5*0.35 | 5.6*0.35 |
| Depth of cavity 20r (length*width) (μm) | 15 | 15 | 15 | 15 |
| Thickness of electronic component 30 (mm) | 700 | 700 | 700 | 200 |
| Size of optical element 80 (length*width) (mm) | 6*1.6 | 6.4*1.6 | 6.9*1.6 | 6*1.6 |
| Thickness of optical element 80 (length*width) (μm) | 200 | 200 | 200 | 200 |
| CTE of optical element 80 (ppm/° C.) | 3 | 4.6 | 4.6 | 4.6 |
| Warpage (μm) | | | | |
| Entire surface at RT | 5.61 | 4.87 | 4.16 | 3.51 |
| Entire surface at 260° C. | 4.12 | 11.66 | 13.91 | 14.11 |
| Local portion at RT | 2.73 | 2.16 | 2.23 | 1.63 |
| Local portion at 260° C. | 2.73 | 7.78 | 9.17 | 7.35 |

Examples C1 to C9 represent the various factors that have been adjusted to modify the structure of the electronic devices and the simulated warpage of these modified structures. As shown in Tables 1-2, when the reinforcement element 40 is not arranged in the electronic device, the warpage of the entire structure as well as the warpage of the local portion of the structure may be relatively high.

FIG. 2G and FIG. 2H show simulation results of warpage of electronic devices in accordance with some arrangements of the present disclosure. FIG. 2G shows a simulation result of warpage of an electronic device having a structure similar to that shown in FIG. 2A without the reinforcement element 40, and the FIG. 2H shows a simulation result of warpage of the electronic device 2A shown in FIG. 2A. The depth of the color indicates the severity of the warpage: the darker the color, the more severe the warpage; the lighter the color, the more minor the warpage.

As shown in FIG. 2G, the warpage at the cavity 20r is relatively severe due to the relatively weak structure of the region R2 (or the thin region) of the photonic component 20. In contrast, as shown in FIG. 2H, with the arrangement of the reinforcement element 40, the warpage is relatively low.

Currently, a photonic component in a CPO structure is usually optically coupled to optical fibers by edge coupling between the optical fibers and waveguides exposed by an edge of the photonic component. Therefore, it would be difficult to perform an optoelectronic inspection on a wafer-level photonic structure, which may be performed from above the wafer-level photonic structure instead of from edges thereof, unless a singulation operation is performed to expose the waveguides from edges of the singulated photonic structure.

According to some arrangements of the present disclosure, the optical element 80 (or the optical guiding element) is arranged between the optical channels 240 and the optical component 60 to allow optical signals from the optical channels 240 to vertically couple to the optical fibers 610 of the optical component 60, and thus an optoelectronic inspection from above the optical element 80 through vertical coupling can be performed before a singulation operation. Therefore, only the singulated units (e.g., photonic components 20 with the electronic components 30 disposed thereon) pass the inspection may be further connected to the substrate 10 to form the electronic device, and the singulated units (e.g., photonic components 20 with the electronic components 30 disposed thereon) fail the inspection may be discarded or reworked. As such, only the singulated unit considered as a “know-good-die” may be used to form the electronic device. Therefore, the manufacturing process of the electronic device can be simplified without having to be reworked if the photonic component 20 of the singulated unit is determined to fail the inspection after singulation, and the cost can be reduced.

In addition, according to some arrangements of the present disclosure, the optical element 80 includes a reflective element (e.g., the portion 82p1) in a cavity 20r that faces the exposed optical channel 240, and the optical director 92 and the reflective element (e.g., the portion 82p1) collectively are configured to transmit the optical signal between the photonic component 20 and the optical component 60 and reduce or enlarge a beam size of the optical signal to satisfy the different widths of the optical channel 240 and the optical fiber 610. Therefore, the reflective element (e.g., the portion 82p1) in the cavity 20r of the photonic component 20 allows the optical element 80 to interlock with the photonic component 20. In addition, a vertical coupling can be achieved without arranging a grating coupler, and the beam size of the optical signal from the optical channel 240 can be enlarged to a relatively large size when it reaches the optical fiber 610, thus the tolerance for optical coupling can be increased.

Moreover, the photonic component 20 requires to be relatively thin to allow the formation of the conductive vias 20v within the photonic component 20, so as to allow the photonic component 20 to serve as an interposer that connects the electronic component 30 to the substrate 10. However, the relatively thin photonic component 20 may suffer from warpage due to its relatively low structural strength, and the photonic component 20 may be further deformed seriously at the region R2 with the cavity 20r and thereby damaged or cracked due to its relatively low structural strength. In addition, an underfill may be used to encapsulate conductive bumps that connect the electronic component 30 to the photonic component 20 and have a relatively high CTE (e.g. about 27 or higher), and thus it may result in a relatively large CTE difference between the underfill and the substrate layer of the photonic component 20. Therefore, warpage or delamination may occur.

According to some arrangements of the present disclosure, the reinforcement element 40 can fill the space around electronic component 30 and the optical element 80, so as to form an integrated structure, which includes the photonic component 20, the electronic component 30, the reinforcement element 40 and the optical element 80, having an increased and relatively uniform thickness. As such, the structural strength of the entire electronic device can be increased significantly. Therefore, the warpage can be reduced, the optical alignment can be improved, and the optical coupling efficiency can be increased.

In addition, according to some arrangements of the present disclosure, the dielectric layer 210d free from covering lateral surfaces of the electronic component 30 has a relatively small thickness compared to the thickness of a conventional underfill. As such, the contribution from the CTE of the dielectric layer 210d to the equivalent CTE of the entire electronic device is relatively small. Therefore, the equivalent CTE of the entire electronic device is mainly resulted from the contribution of the substrate layers (e.g., Si layers) of the photonic component 20 and the electronic component 30 and the body (e.g., dummy Si layer) of the optical element 80, which is relatively low, and thus warpage that could have been due to high CTE of the materials of the electronic device can be mitigated or prevented.

Furthermore, according to some arrangements of the present disclosure, the protrusion 94 of the photonic plug 90 is engaged with a recess (e.g., the alignment region 40r) of the reinforcement element 40 instead of a region (e.g., a recess or a cavity) at an upper surface of the photonic component 20. Since the photonic plug 90 may be attached to and detached from the electronic device multiple times during use, abrasion or chipping may occur at the surface that contacts or engages with the photonic plug 90. With the above design, the photonic component 20 is free from contacting the photonic plug 90 and thus can be prevented from being damaged, and the optical self-alignment between the optical component 60 and the optical element 80 can still be realized by the engagement between the photonic plug 90 and the recess (e.g., the alignment region 40r) of the reinforcement element 40.

Moreover, according to some arrangements of the present disclosure, the space between the reflective element (e.g., the portion 82p1) and sidewalls of the cavity 20r is filled with the optical gel 81 with substantially no air in the cavity 20r. As such, the optical gel 81 can prevent the optical signal that is transmitted from the optical channel 240 to the optical element 80 from scattering when travelling through air. Therefore, the optical coupling efficiency can be increased.

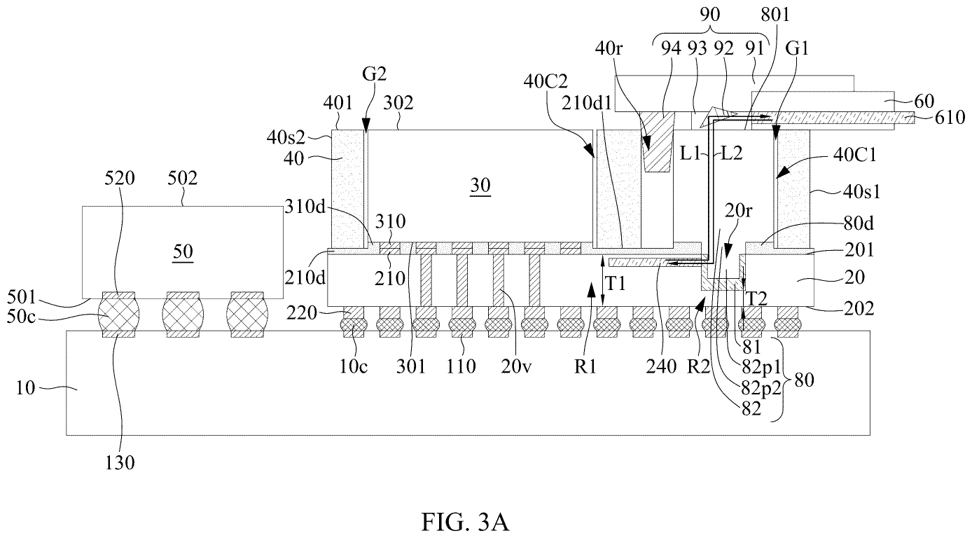

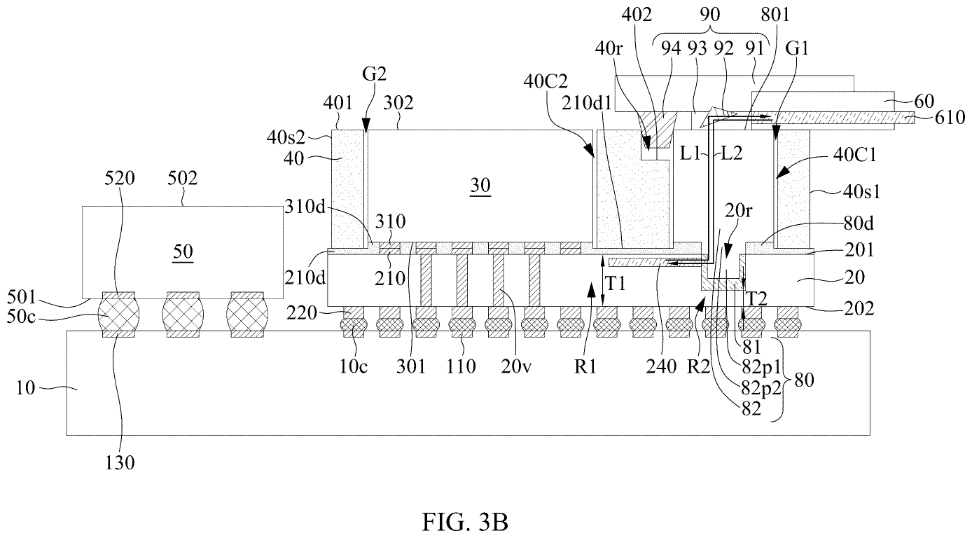

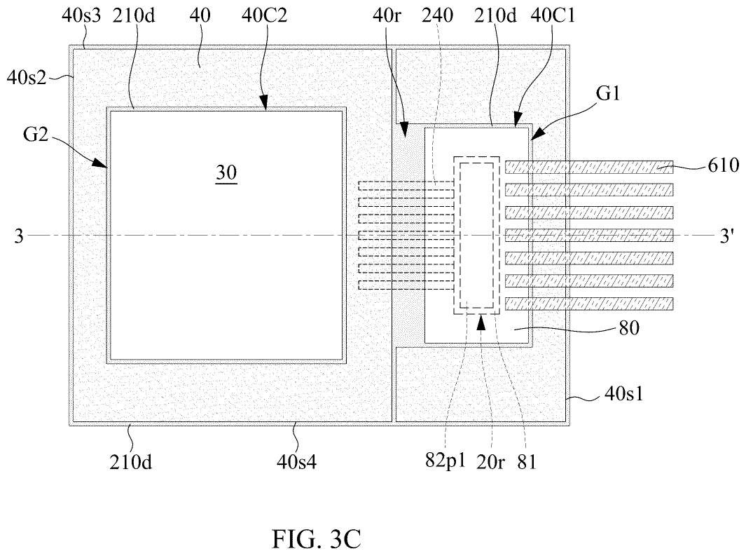

FIG. 3A is a cross-section of an electronic device 3A in accordance with some arrangements of the present disclosure. The electronic device 3A is similar to the electronic device 2A, and the differences therebetween are described as follows.

In some arrangements, the alignment region 40r of the reinforcement element 40 is or includes a recess or a cavity recessed from the upper surface 401 of the reinforcement element 40. In some arrangements, a portion of the optical element 80 is exposed to the recess or cavity. A bottom surface of the recess or the cavity may be defined by an upper surface 210d1 of the dielectric layer 210d. The recess or the cavity may extend between the upper surface 401 and a bottom surface of the reinforcement element 40. The recess or the cavity may be a through trench penetrating the reinforcement element 40. The optical director 92 may include a lens, a prism, or a combination thereof. In some arrangements, the protrusion 94 is configured to engage with the recess or the cavity (e.g., the alignment region 40r) defined by the reinforcement element 40. The protrusion 94 may be accommodated by the recess or the cavity and limited or confined by the reinforcement element 40 and the optical element 80 to fix the photonic plug 90 to the electronic device 3A. In some arrangements, the protrusion 94 is limited or confined between one or more side walls of the reinforcement element 40 and one or more sidewalls of the optical element 80 to fix the photonic plug 90 to the electronic device 3A.

FIG. 3B is a cross-section of an electronic device 3B in accordance with some arrangements of the present disclosure. The electronic device 3B is similar to the electronic device 3A, and the differences therebetween are described as follows.

In some arrangements, the alignment region 40r of the reinforcement element 40 is or includes a recess or a cavity recessed from the upper surface 401 of the reinforcement element 40. In some arrangements, a portion of the optical element 80 is exposed to the recess or cavity. A bottom surface of the recess or the cavity may be defined by the upper surface 402 of the reinforcement element 40. The protrusion 94 may be accommodated by the recess or the cavity and limited or confined by the reinforcement element 40 and the optical element 80 to fix the photonic plug 90 to the electronic device 3B. In some arrangements, the protrusion 94 is limited or confined between one or more side walls of the reinforcement element 40 and one or more sidewalls of the optical element 80 to fix the photonic plug 90 to the electronic device 3B.

FIG. 3C is a top view of an electronic device 3C in accordance with some arrangements of the present disclosure. In some arrangements, FIG. 3A shows a cross-section along a line 3-3′ in FIG. 3C. In some arrangements, FIG. 3B shows a cross-section along a line 3-3′ in FIG. 3C.

In some arrangements, the recess or cavity (e.g., the alignment region 40r) of the reinforcement element 40 is defined by lateral surfaces of the reinforcement element 40 and a lateral surface of the optical element 80.

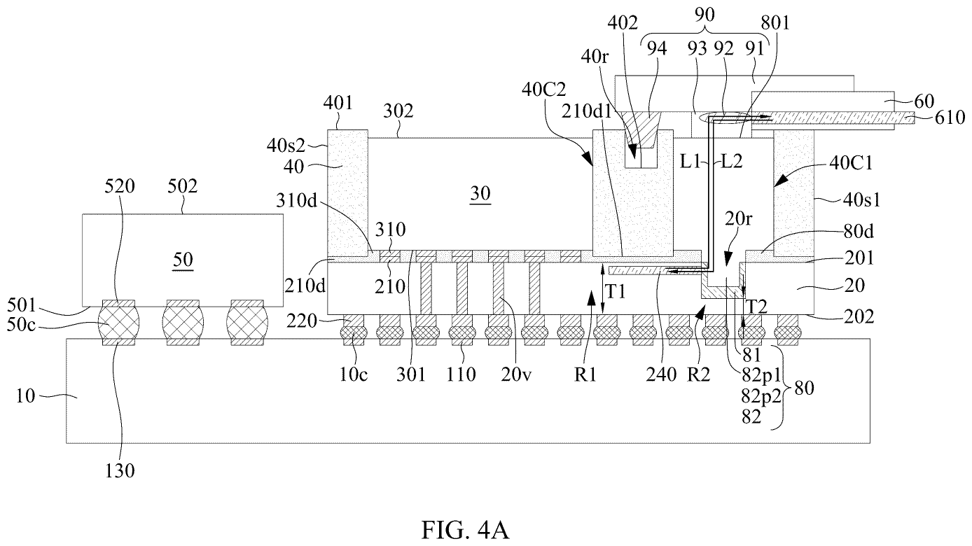

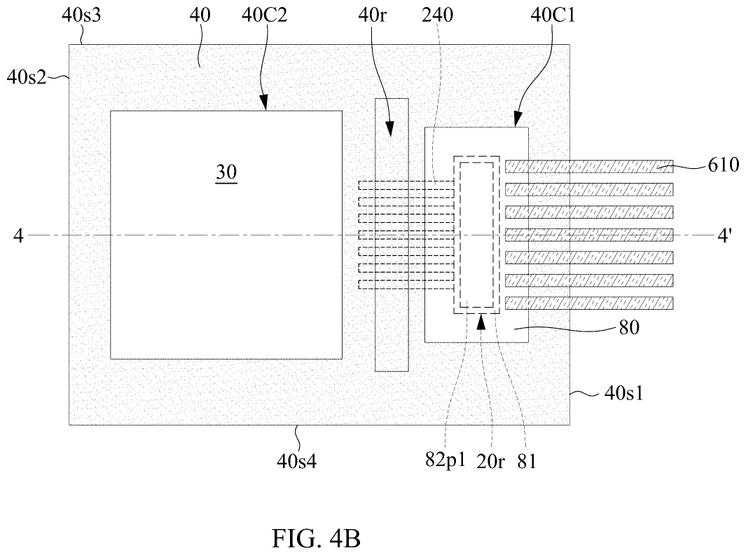

FIG. 4A is a cross-section of an electronic device 4 in accordance with some arrangements of the present disclosure. FIG. 4B is a top view of an electronic device 4 in accordance with some arrangements of the present disclosure. In some arrangements, FIG. 4A shows a cross-section along a line 4-4′ in FIG. 4B. The electronic device 4 is similar to the electronic device 2A, and the differences therebetween are described as follows.

In some arrangements, the reinforcement element 40 contacts the optical element 80 and the electronic component 30. In some arrangements, the reinforcement element 40 includes an encapsulant. The encapsulant may include an epoxy resin having fillers dispersed therein, a molding compound (e.g., an epoxy molding compound or other molding compound), polyimide (PI), a phenolic compound or material, a polymer material with silicone dispersed therein, or a combination thereof. In some arrangements, an upper surface (e.g., the surface 302) of the electronic component 30 is recessed with respect to the upper surface 401 of the reinforcement element 40. In some arrangements, lateral surfaces 40s1, 40s2, 40s3, and 40s4 of the reinforcement element 40 are substantially aligned with lateral surfaces of the dielectric layer 210d. In some arrangements, the upper surface (e.g., the surface 302) of the electronic component 30 is protruded beyond the upper surface 401 of the reinforcement element 40. In some arrangements, the upper surface (e.g., the surface 302) of the electronic component 30 is at an elevation higher than that of the upper surface 401 of the reinforcement element 40 with respect to the surface 201. In some arrangements, the reinforcement element 40 includes a portion (also referred to as “an extension”) extending over a portion of the surface 302, and the portion (or the extension) has the upper surface 401 which includes a curved surface extending toward the surface 302 of the electronic component 30.

According to some arrangements of the present disclosure, the reinforcement element 40 is formed of an encapsulant that contacts the electronic component 30 and the optical element 80 with gaps formed therebetween, and upper surfaces of the electronic component 30 and the optical element 80 are exposed by the encapsulant. Therefore, the structural strength of the entire structure of the electronic device 4 can be increased, the exposed upper surface of the optical element 80 allows the optical signal to pass through, and the exposed upper surface of the electronic component 30 is advantageous to the heat dissipation from the electronic component 30.

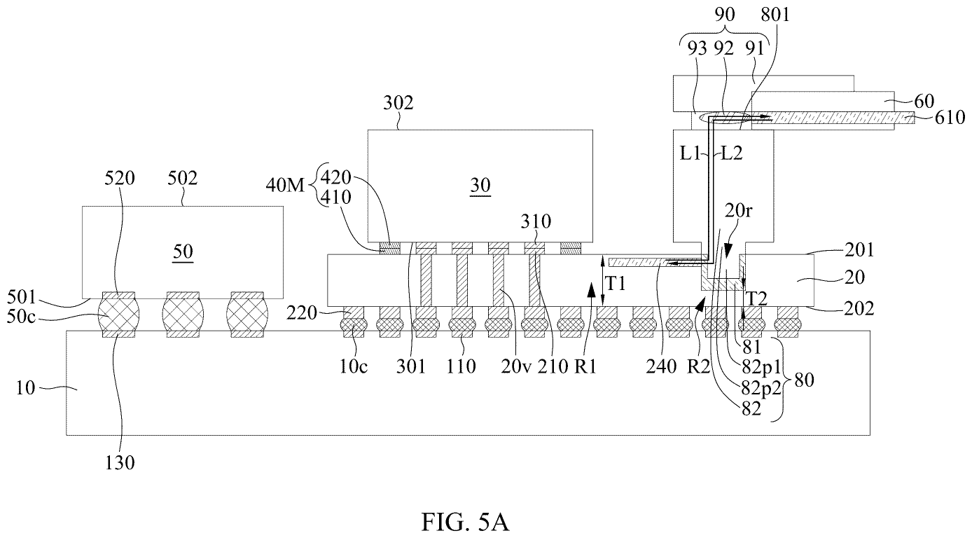

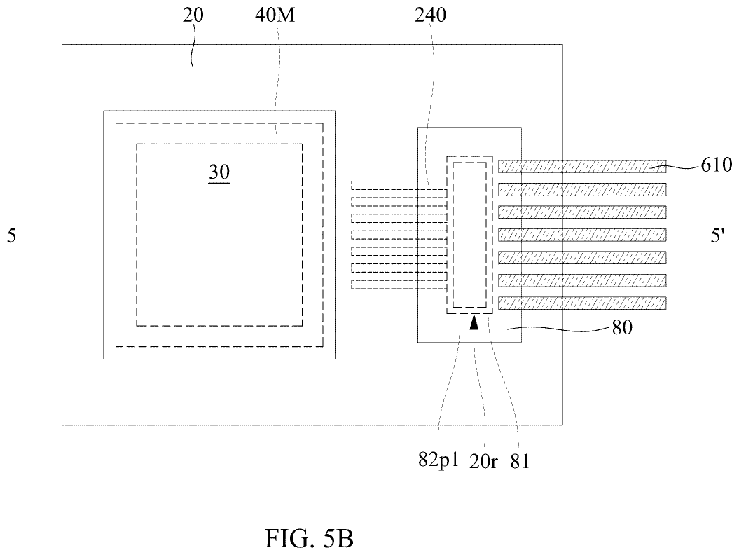

FIG. 5A is a cross-section of an electronic device 5 in accordance with some arrangements of the present disclosure. FIG. 5B is a top view of an electronic device 5 in accordance with some arrangements of the present disclosure. In some arrangements, FIG. 5A shows a cross-section along a line 5-5′ in FIG. 5B. The electronic device 5 is similar to the electronic device 2A, and the differences therebetween are described as follows.

In some arrangements, the reinforcement element 40M of the electronic device 5 is between the electronic component 30 and the photonic component 20 and connects the electronic component 30 to the photonic component 20. In some arrangements, the reinforcement element 40M is disposed at a peripheral region of the electronic component 30. In some arrangements, the reinforcement element 40M includes a ring-shaped structure. In some arrangements, the reinforcement element 40M surrounds the conductive pads 210 and 310.

In some arrangements, the reinforcement element 40M includes layers 410 and 420 (also referred to as “dummy conductive layers”). In some arrangements, the layer 420 is connected to the layer 410 through a direct bonding process or a thermal bonding process. In some arrangements, the reinforcement element 40M includes a metal material. In some arrangements, the layer 410 and the conductive pads 210 include the same material and formed by the same process. In some arrangements, the layer 420 and the conductive pads 310 include the same material and formed by the same process.

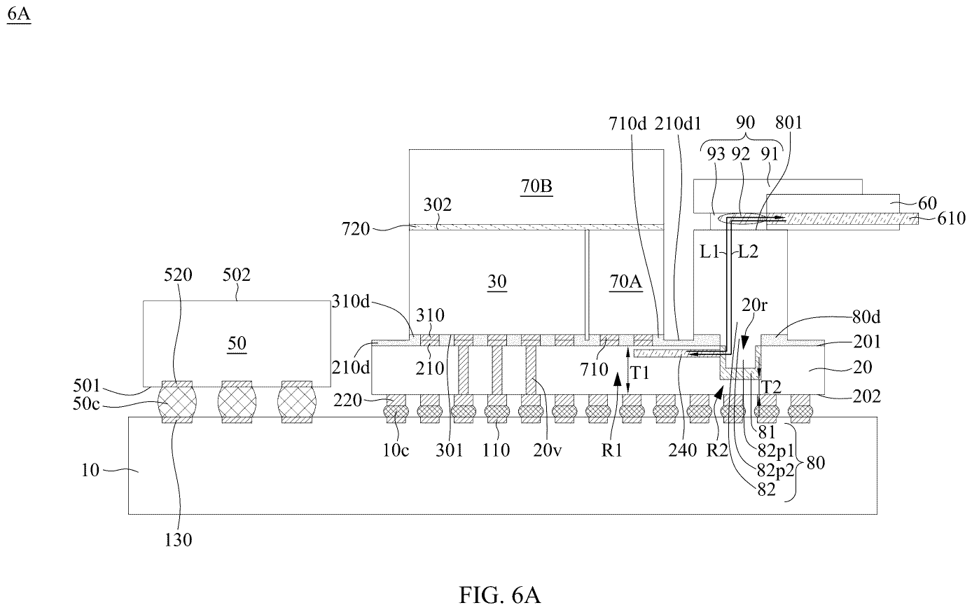

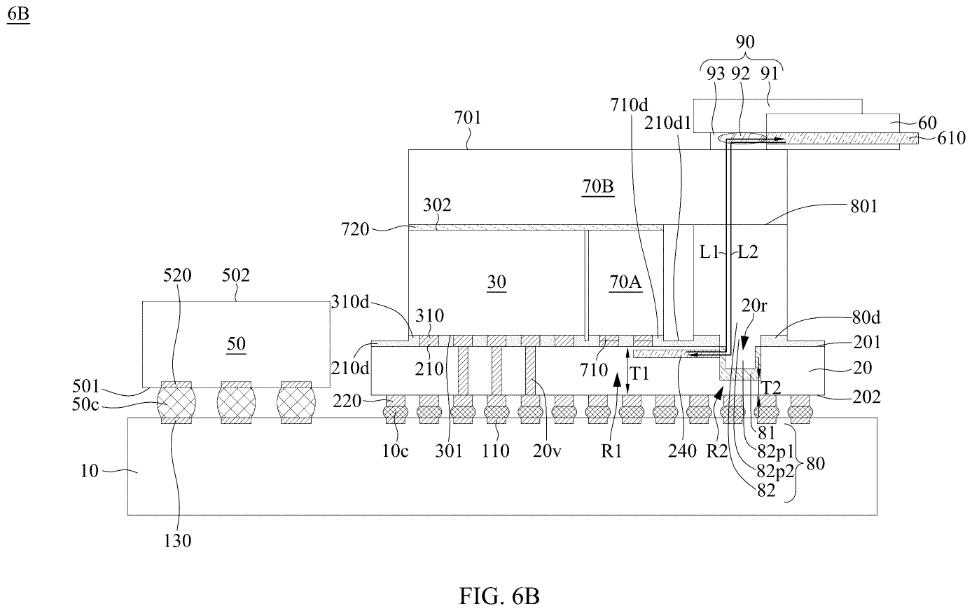

FIG. 6A is a cross-section of an electronic device 6A in accordance with some arrangements of the present disclosure. The electronic device 6A is similar to the electronic device 2A, and the differences therebetween are described as follows.

In some arrangements, the reinforcement element of the electronic device 6A includes portions 70A and 70B (also referred to as “reinforcement portions”). In some arrangements, the portion 70A is between the electronic component 30 and the optical element 80. In some arrangements, the portion 70A is connected to the photonic component 20. In some arrangements, the portion 70A is connected to the photonic component 20 through an electrically isolated connection element. The electrically isolated connection element may include a dummy connection element. In some arrangements, the portion 70A includes pads 710 and a dielectric layer 710d. In some arrangements, the pad 710 (also referred to as “a dummy conductive pad”, “a dummy conductive bump” or “an electrically isolated pad”) of the portion 70A is connected to the conductive pad 210 through a direct bonding process or a thermal bonding process. The pads 710 may include Au, Ag, Al, Cu, Ni, or an alloy thereof.

In some arrangements, the portion 70A includes a discrete component. In some arrangements, the portion 70A is distinct from the photonic component 20. In some arrangements, the portion 70A is free of a logic circuit. In some arrangements, the portion 70A includes a dummy substrate (e.g., a dummy silicon substrate). In some arrangements, the portion 70A includes a dummy die. In some arrangements, the portion 70A includes a dummy die free of a logic circuit. The portion 70A may have a thickness substantially the same as the thickness of the electronic component 30.

In some arrangements, the portion 70B is disposed over the electronic component 30 and the portion 70A. In some arrangements, the portion 70B is supported by the electronic component 30 and the portion 70A. In some arrangements, the portion 70B is connected to the electronic component 30 and the portion 70A through an adhesive layer 720. The adhesive layer 720 may be or include an insulating adhesive. The adhesive layer 720 may be or include a die attach film (DAF). The adhesive layer 720 may include a thermal interface material (TIM).

In some arrangements, the portion 70B includes a discrete component. In some arrangements, the portion 70B is distinct from the photonic component 20, the electronic component 30, and the portion 70A. In some arrangements, the portion 70B is free of a logic circuit. In some arrangements, the portion 70B includes a dummy substrate (e.g., a dummy silicon substrate). In some arrangements, the portion 70B includes a dummy die. In some arrangements, the portion 70B includes a dummy die free of a logic circuit.

FIG. 6B is a cross-section of an electronic device 6B in accordance with some arrangements of the present disclosure. The electronic device 6B is similar to the electronic device 6A, and the differences therebetween are described as follows.

In some arrangements, the portion 70B extends beyond an edge of the portion 70A and connects to the optical element 80. In some arrangements, the overhang portion of the portion 70B contacts the upper surface 801 of the optical element 80 and a lower surface of the covering element 93 of the photonic plug 90. In some arrangements, the optical signals L1 and L2 may be transmitted through the portion 70B to optically couple to the photonic plug 90 and the photonic component 20.

In some arrangements, the optical component 60 is disposed over the portion 70B of the reinforcement element and configured to optically couple to the photonic component 20 through the optical element 80. In some arrangements, the portion 70B of the reinforcement element contacts the upper surface 801 of the optical element 80.

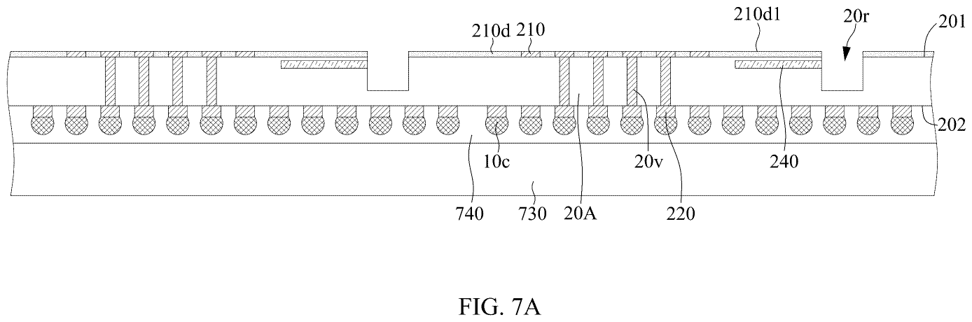

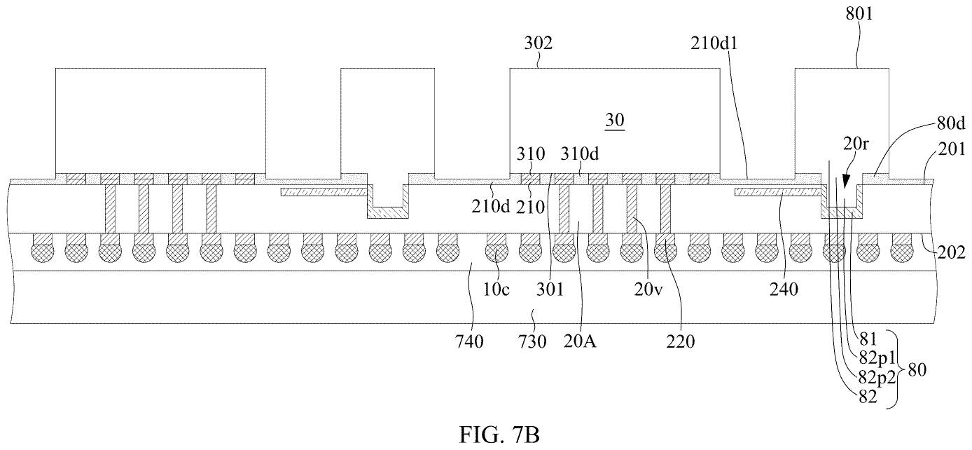

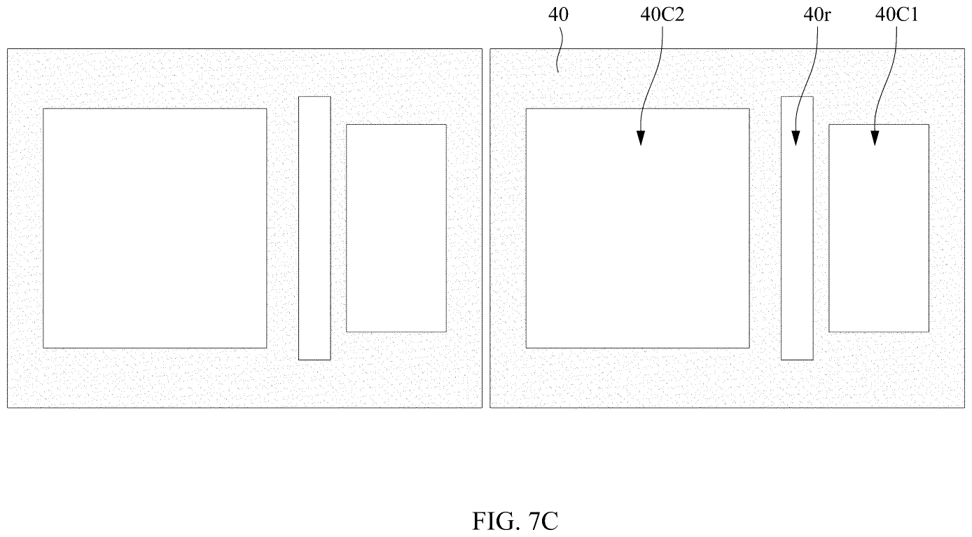

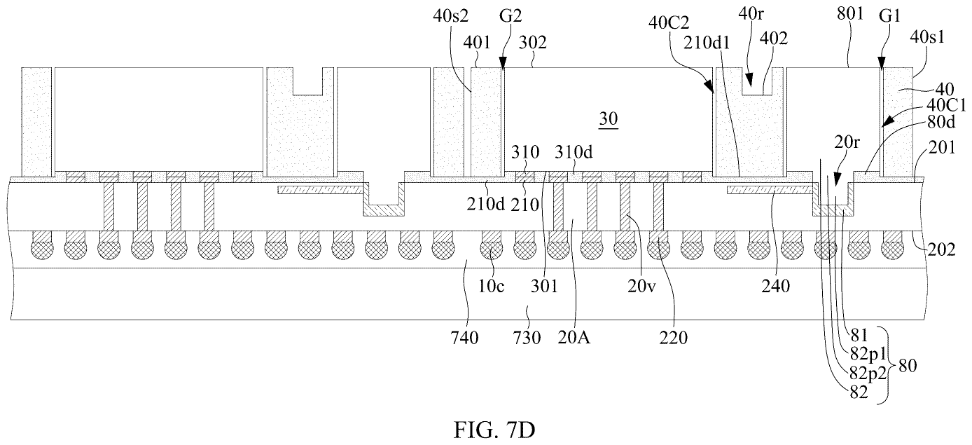

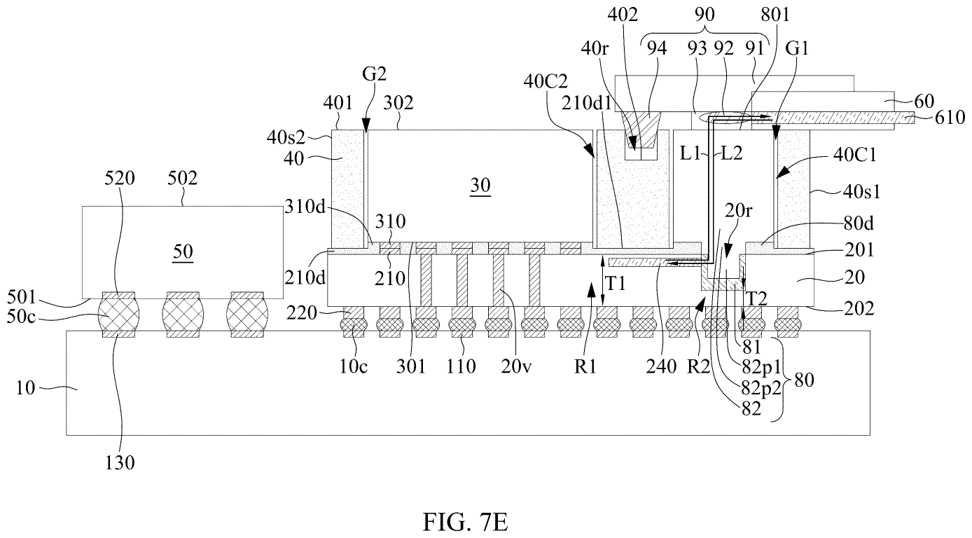

FIG. 7A, FIG. 7B, FIG. 7C, FIG. 7D, and FIG. 7E illustrate various stages of an exemplary method for manufacturing an electronic device 2A in accordance with some embodiments of the present disclosure.

Referring to FIG. 7A, a wafer-level photonic structure 20A may be provided. In some arrangements, the wafer-level photonic structure 20A is formed by providing a wafer (or a wafer-level substrate layer), forming optical channels 240 in the wafer, forming conductive vias 20v extending between surfaces 201 and 202, forming conductive pads 210 and 220 on the surfaces 201 and 202 respectively, forming a dielectric layer 210d, and forming cavities 20r that expose the optical channels 240. In some arrangements, electrical contacts 10c are formed on the conductive pads 220. In some arrangements, a buffer layer 740 is formed on a rigid carrier 730, and the as-formed wafer-level photonic structure 20A is disposed over the rigid carrier 730 with the conductive pads 220 and the electrical contacts 10c embedded in the buffer layer 740.

Referring to FIG. 7B, electronic components 30 may be hybrid-bonded to the photonic structure 20A, and optical elements 80 may be thermally bonded to the photonic structure 20A. In some arrangements, portions 82p1 and optical gels 81 of the optical elements 80 are filled in the cavities 20r of the photonic structure 20A. In some arrangements, an upper surface 210d1 of the dielectric layer 210d is partially exposed by the electronic components 30 and the optical elements 80.

Referring to FIG. 7C, a plurality of reinforcement elements 40 may be provided. In some arrangements, the reinforcement element 40 includes through holes 40C1 and 40C2 and an alignment region 40r.

Referring to FIG. 7D, the reinforcement elements 40 may be disposed on and connected to the photonic structure 20A. In some arrangements, the reinforcement elements 40 are thermally bonded to the photonic structure 20A.

Still referring to FIG. 7D, an optoelectronic inspection may be performed on the wafer-level photonic structure 20A by allowing optical signals from the optical channels 240 of the photonic structure 20A to transmit through the optical element 80 so as to optically couple to an optical component over the optical element 80. The inspection may be or include a detection of an amount of optical coupling through vertical coupling.

Referring to FIG. 7E, the photonic structure 20A may be removed from the rigid carrier 730 and singulated into a plurality of photonic components 20. In some arrangements, the photonic component 20 and an electronic component 50 are disposed on and electrically connected to a substrate 10. In some arrangements, the singulation operation may be performed after the optoelectronic inspection is performed. In some arrangements, only the singulated units (e.g., photonic components 20 with the electronic components 30 disposed thereon) pass the inspection may be further connected to the substrate 10 to form an electronic device. In some arrangements, the singulated units (e.g., photonic components 20 with the electronic components 30 disposed thereon) fail the inspection may be discarded or reworked. In some arrangements, an optical component 60 is coupled to the optical element 80 through a photonic plug 90. As such, the electronic device 2A as illustrated in FIG. 2A may be formed.

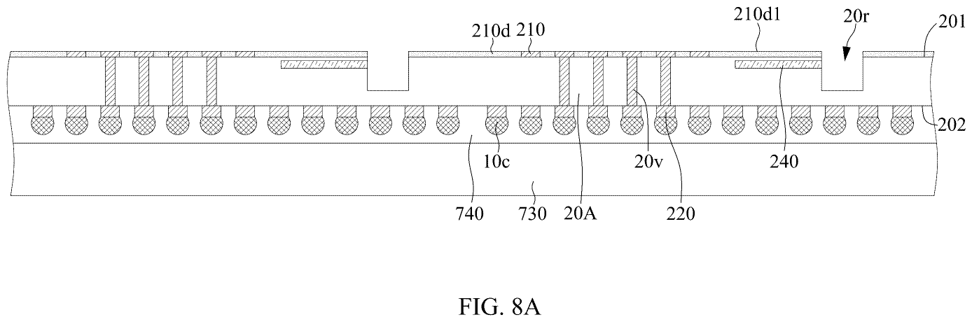

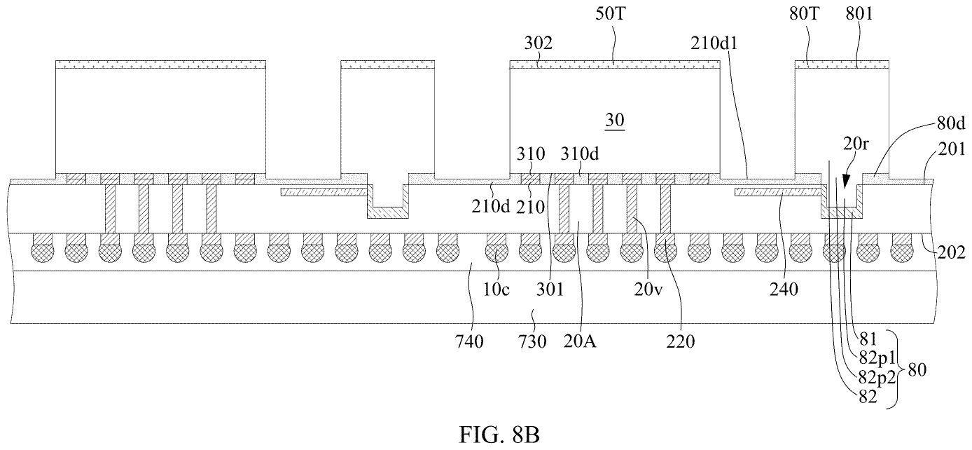

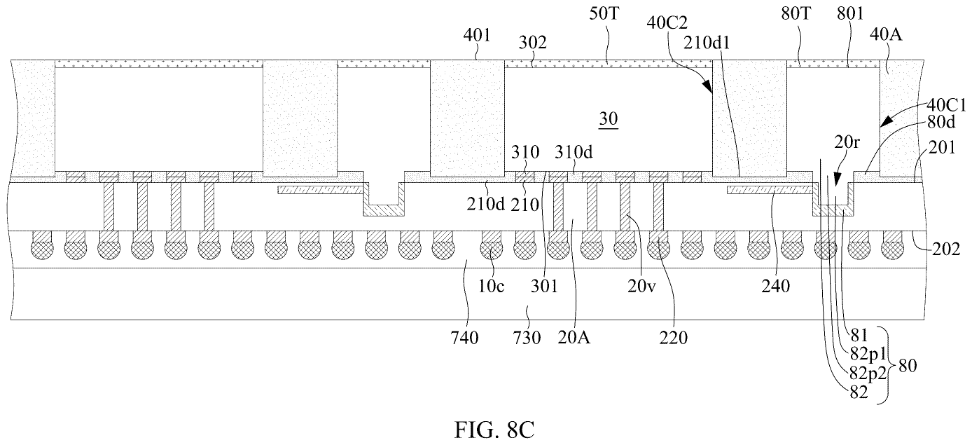

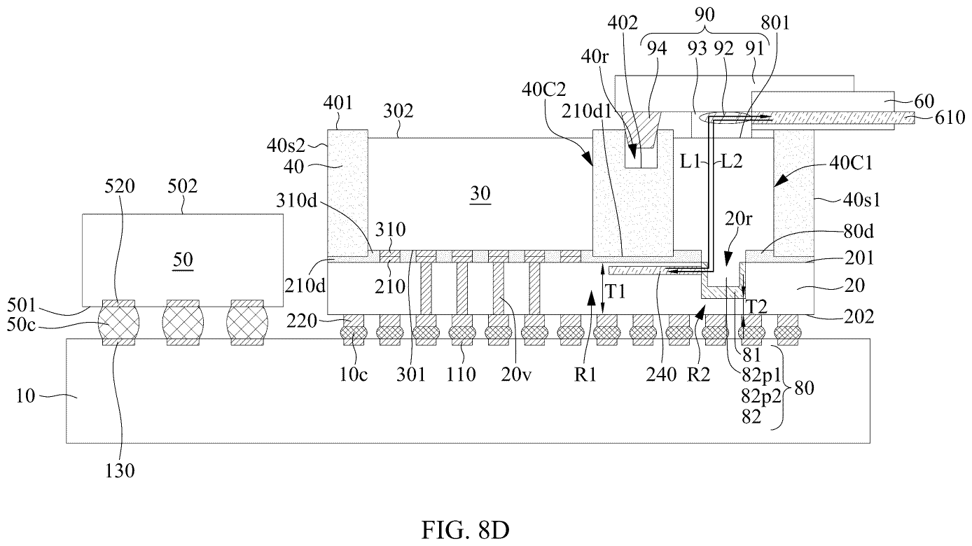

FIG. 8A, FIG. 8B, FIG. 8C, and FIG. 8D illustrate various stages of an exemplary method for manufacturing an electronic device 4 in accordance with some embodiments of the present disclosure.

Referring to FIG. 8A, operations similar to those illustrated in FIG. 7A may be performed to form a wafer-level photonic structure 20A and dispose the photonic structure 20A over a rigid carrier 730.

Referring to FIG. 8B, operations similar to those illustrated in FIG. 7B may be performed to bond or connect electronic components 30 and optical elements 80 to the photonic structure 20A, and protective layers 50T and 80T may be disposed on a surface 302 and an upper surface 801 to cover the surface 302 and the upper surface 801. In some arrangements, the protective layers 50T and 80T may be or include release film, e.g., tapes.

Referring to FIG. 8C, an encapsulant 40A may be formed to cover the electronic components 30, the optical elements 80, and the exposed upper surface 210d1 of the dielectric layer 210d. In some arrangements, the protective layers 50T and 80T are exposed by the encapsulant 40A. In some arrangements, the encapsulant 40A partially covers the protective layers 50T and 80T.

Referring to FIG. 8D, the photonic structure 20A may be removed from the rigid carrier 730 and singulated into a plurality of photonic components 20. In some arrangements, the singulation operation may be performed after an optoelectronic inspection as illustrated in FIG. 7D is performed. In some arrangements, the protective layers 50T and 80T are removed. In some arrangements, the photonic component 20 and an electronic component 50 are disposed on and electrically connected to a substrate 10, and an optical component 60 is coupled to the optical element 80 through a photonic plug 90. As such, the electronic device 4 as illustrated in FIG. 4A may be formed.

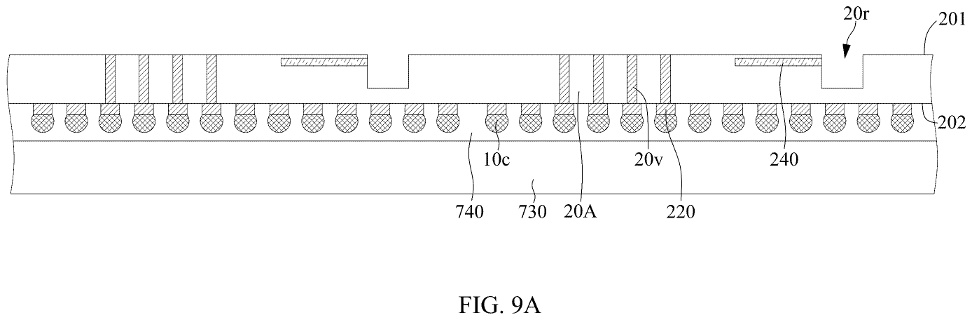

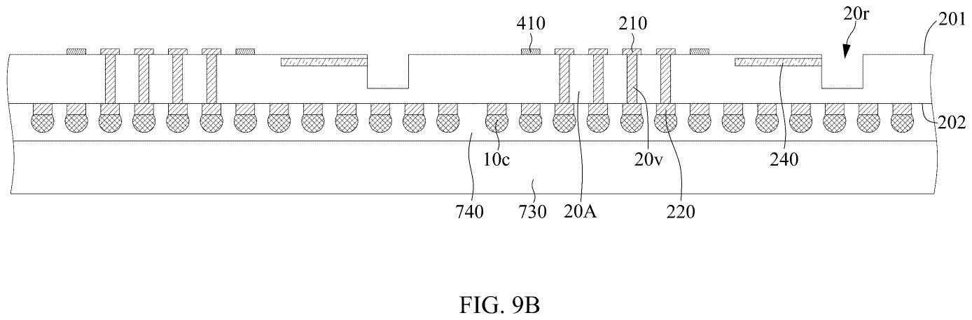

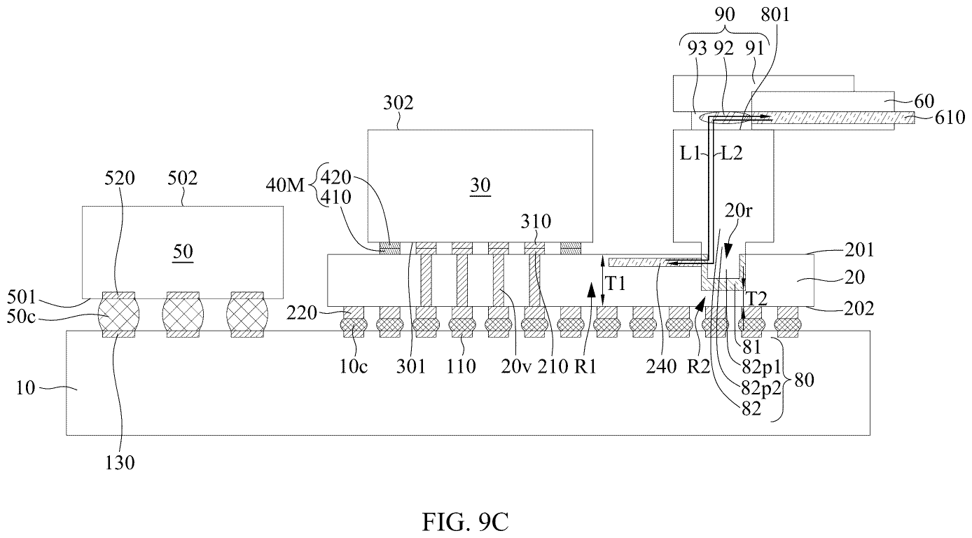

FIG. 9A, FIG. 9B, and FIG. 9C illustrate various stages of an exemplary method for manufacturing an electronic device 5 in accordance with some embodiments of the present disclosure.

Referring to FIG. 9A, operations similar to those illustrated in FIG. 7A may be performed to form a wafer-level photonic structure 20A and dispose the photonic structure 20A over a rigid carrier 730, except that the photonic structure 20A shown in FIG. 9A does not include a dielectric layer 210d.

Referring to FIG. 9B, conductive pads 210 and a layer 410 may be formed on the surface 201 of the photonic structure 20A.

Referring to FIG. 9C, the photonic structure 20A may be removed from the rigid carrier 730 and singulated into a plurality of photonic components 20. In some arrangements, the singulation operation may be performed after an optoelectronic inspection as illustrated in FIG. 7D is performed. In some arrangements, an electronic component 30 is connected to the photonic component 20 through a direct bonding process, and an optical element 80 is connected to the photonic component 20. In some arrangements, the photonic component 20 and an electronic component 50 are disposed on and electrically connected to a substrate 10, and an optical component 60 is coupled to the optical element 80 through a photonic plug 90. As such, the electronic device 5 as illustrated in FIG. 5A may be formed.

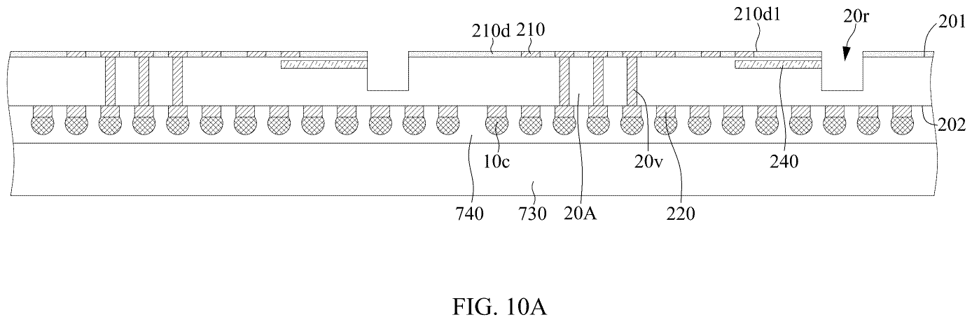

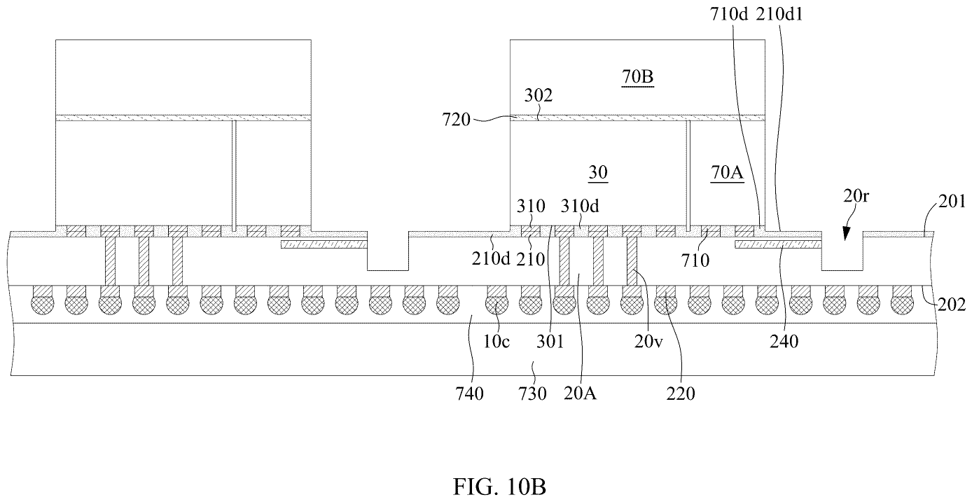

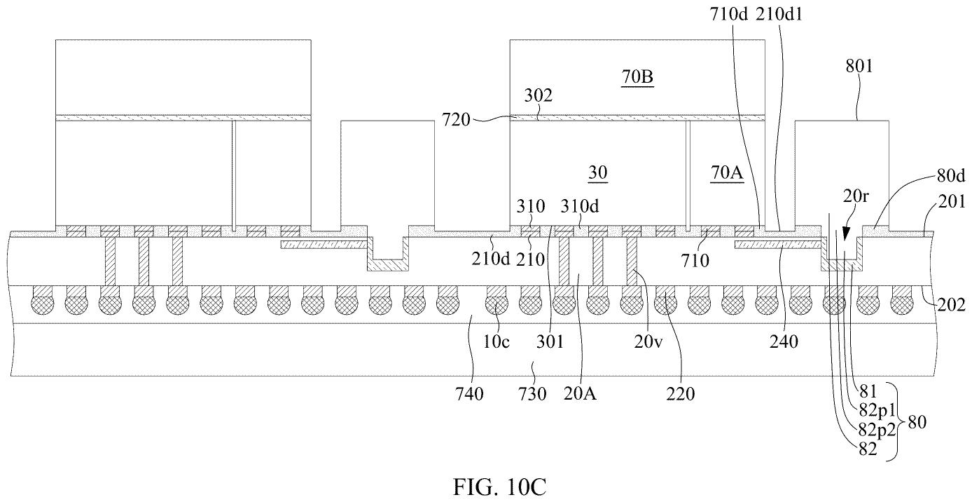

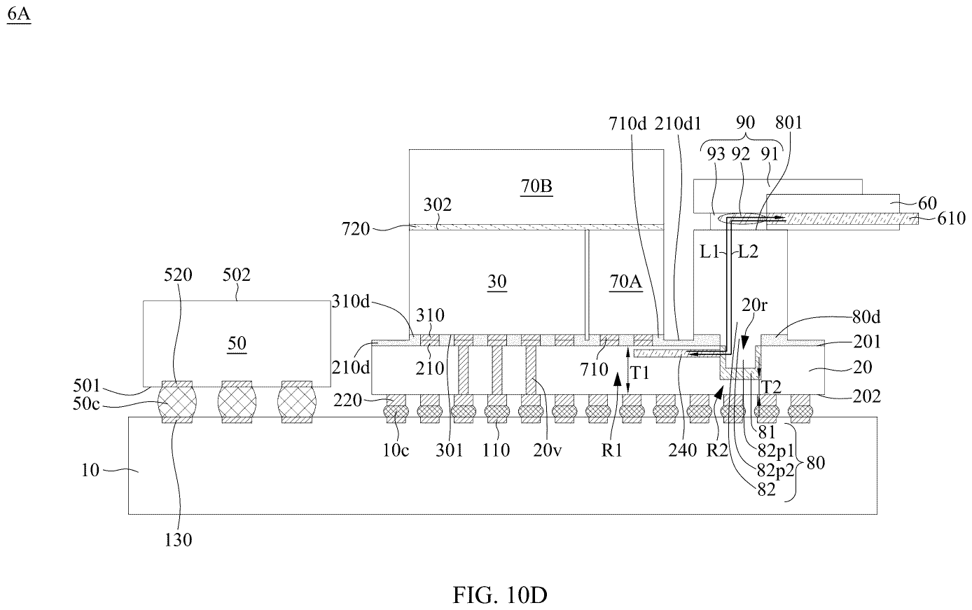

FIG. 10A, FIG. 10B, FIG. 10C, and FIG. 10D illustrate various stages of an exemplary method for manufacturing an electronic device 6A in accordance with some embodiments of the present disclosure.

Referring to FIG. 10A, operations similar to those illustrated in FIG. 7A may be performed to form a wafer-level photonic structure 20A and dispose the photonic structure 20A over a rigid carrier 730.

Referring to FIG. 10B, electronic components 30 may be hybrid-bonded to the photonic structure 20A, portions 70A of reinforcement elements may be connected to the photonic structure 20A through a direct bonding process or a thermal bonding process, and portions 70B of the reinforcement elements may be connected to the electronic components 30 and the portions 70A through adhesive layers 720.

Referring to FIG. 10C, optical elements 80 may be connected to the photonic structure 20A through a thermal bonding process.

Referring to FIG. 10D, the photonic structure 20A may be removed from the rigid carrier 730 and singulated into a plurality of photonic components 20. In some arrangements, the singulation operation may be performed after an optoelectronic inspection as illustrated in FIG. 7D is performed. In some arrangements, the photonic component 20 and an electronic component 50 are disposed on and electrically connected to a substrate 10, and an optical component 60 is coupled to the optical element 80 through a photonic plug 90. As such, the electronic device 6A as illustrated in FIG. 6A may be formed.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated from by such an arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Two surfaces can be deemed to be coplanar or substantially coplanar if a displacement between the two surfaces is no greater than 5 μm, no greater than 2 μm, no greater than 1 μm, or no greater than 0.5 μm. A surface can be deemed to be substantially flat if a displacement between a highest point and a lowest point of the surface is no greater than 5 μm, no greater than 2 μm, no greater than 1 μm, or no greater than 0.5 μm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 104 S/m, such as at least 105 S/m or at least 106 S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An electronic device, comprising:
a photonic component comprising a first region and a second region having a thickness less than a thickness of the first region;
an optical guiding element disposed over the second region and configured to direct a first optical signal upwardly and away from the photonic component; and
a reinforcement element disposed over the first region.

2. The electronic device as claimed in claim 1, further comprising a photonic connector over the photonic component and the optical guiding element, wherein the optical guiding element is further configured to direct a second optical signal downwardly and away from the photonic connector.

3. The electronic device as claimed in claim 2, wherein the photonic connector is configured to guide the second optical signal to the optical guiding element.

4. The electronic device as claimed in claim 1, further comprising a photonic connector, wherein the reinforcement element defines an alignment region configured to engage with the photonic connector.

5. The electronic device as claimed in claim 1, wherein the photonic component has a cavity defining the second region and comprising an optical channel exposed to the cavity.

6. The electronic device as claimed in claim 5, wherein a portion of the optical guiding element is disposed in the cavity.

7. The electronic device as claimed in claim 1, wherein the reinforcement element is around the optical guiding element.

8. The electronic device as claimed in claim 1, wherein the reinforcement element comprises a plurality of reinforcement parts spaced apart from one another.

9. The electronic device as claimed in claim 1, further comprising an electronic component disposed over the first region and spaced apart from the optical guiding element by the reinforcement element.

10. The electronic device as claimed in claim 9, wherein the reinforcement element connects the electronic component to the photonic component and is disposed at a peripheral region of the electronic component.

11. The electronic device as claimed in claim 9, wherein the reinforcement element comprises a first portion between the electronic component and the optical guiding element and a second portion over the electronic component and the first portion.

12. An electronic device, comprising:
a photonic component having a non-uniform thickness;
an optical component disposed over the photonic component;
an optical guiding element configured to optically couple the photonic component to the optical component; and
a leveling element configured to increase an optical coupling efficiency between the photonic component and the optical component.

13. The electronic device as claimed in claim 12, wherein the leveling element is disposed between the photonic component and the optical component.

14. The electronic device as claimed in claim 12, wherein the leveling element defines a space for accommodating the optical guiding element.

15. The electronic device as claimed in claim 14, wherein the photonic component has a recess under the space, and the optical guiding element comprises a reflective element in the recess.

16. The electronic device as claimed in claim 15, further comprising a photonic connector optically coupled to the optical component, wherein the photonic connector comprises an optical director disposed over the optical guiding element.

17. The electronic device as claimed in claim 16, wherein the optical director and the reflective element collectively are configured to transmit an optical signal from the photonic component and change a beam size of the optical signal.

18. An electronic device, comprising:
a photonic component having a cavity;
an optical guiding element configured to optically couple to the photonic component and comprising an extension in the cavity; and
a reinforcement element disposed over the photonic component and around the optical guiding element.

19. The electronic device as claimed in claim 18, wherein the optical guiding element further comprises an optical gel in the cavity.

20. The electronic device as claimed in claim 19, wherein the photonic component comprises an optical channel exposed to the cavity and contacting the optical gel.
